(19) United States
(12) Patent Application Publication
(10) Pub. No.: US 2026/0212261 A1
(43) Pub. Date: Jul. 23, 2026

(54) MECHANISMS FOR INTELLIGENT MACHINE LEARNING DATA PREPARATION SERVICE

(71) Applicant: InterDigital Patent Holdings, Inc., Wilmington, DE (US)

(72) Inventors: Quang LY, North Wales, PA (US); Dale SEED, Allentown, PA (US); Lu LIU, Conshohocken, PA (US); William Robert FLYNN, IV, Schwenksville, PA (US); Catalina MLADIN, Hatboro, PA (US)

(73) Assignee: InterDigital Patent Holdings, Inc., Wilmington, DE (US)

(21) Appl. No.: 19/138,719

(22) PCT Filed: Dec. 13, 2023
(86) PCT No.: PCT/US2023/083801

§ 371 Date: Jun. 13, 2025

Related U.S. Application Data
(60) Provisional application No. 63/387,647, filed on Dec. 15, 2022.

(51) Int. Cl. G06N 20/00

(52) U.S. Cl. CPC G06N 20/00

(57) ABSTRACT

Mechanisms for intelligent machine learning data preparation services are described herein. In one aspect, a method by an intelligent data preparation service can include: receiving configuration information from a service provider to configure the data preparation service; receiving, from a user, configuration information comprising output requirements for data processed by the data preparation service and for the user, combining data inputs into a dataset; generating metadata for a set of features of the dataset; analyzing the data inputs, the set of features, and the metadata to derive recommended data preparation operations; selecting another set of features that satisfy the output requirements of the user, based on the user configuration information, the service provider configuration, the feature metadata, dataset context information, and the recommended data preparation operations; and configuring the intelligent data preparation service to manipulate the dataset for machine learning (ML) applications.

### CROSS-REFERENCE TO RELATED APPLICATIONS

This application claims benefit of U.S. Provisional Application No. 63/387,647 titled “Mechanisms for Intelligent Machine Learning Data Preparation Service” filed Dec. 15, 2022, the content of which are hereby incorporated by reference in their entirety for any and all purposes.

### BACKGROUND

The effectiveness of machine learning applications wholly depends on the dataset(s) that are used to train, validate, and test the model. In addition, machine learning algorithms or models may have certain dataset formatting requirements to ensure proper operations, which may require many iterations to complete. Therefore, dataset preparation is crucial in the development of a machine learning workflow in order to generate a clean dataset that is suitable for machine learning algorithms and models.

Data may come from various sources, each with different representations and/or formats even if the data provides the same information. For example, dates may have many different formats and representations such as MM/DD/YYYY, M/D/YY, DD/MM/YY, DD-MMM-YY, YYYYMMDD, “month D, Year”, etc., consisting of alphanumeric characters. Other data may have different units associated with their corresponding values such as temperature, barometric pressure, wind speed, radioactivity, etc. Yet other data may imply certain mathematical scale, e.g. percentage or logarithm, or categorical data which may represent some domain criteria or identification.

Another aspect of machine learning is the datasets are typically large in size, ranging from thousands to millions of data instances. The highly iterative nature of data preparation coupled with the large dataset sizes may frustrate users who are not trained to perform such a task. The large datasets are then divided into training, validation, and test datasets with which the ML algorithm or model is trained and evaluated for performance accuracy. An uninitiated user may feel overwhelmed with all the decisions that need to be made during the whole data preparation process.

To assist users with the overhead and burden of cleaning data samples originating from different data sources and having different formats, data preparation services have been introduced into several commercially deployed ML services and tool suites. Although these services do help users perform data transformation tasks in an assisted manner, they are lacking advanced forms of data preparations such as: the capability to learn which data preparation operations to perform on a dataset based on prior data preparation operations performed by the service on the dataset itself or on similar datasets; and the capability to autonomously configure and recommend data preparation operations performed on a dataset for a particular ML application or user based on user preferences and/or learned behaviors of past data preparation operations requested by many users targeting the desired ML application

### SUMMARY

As data preparation for machine learning applications is a highly iterative and time consuming process, an intelligent data preparation service that provides guidance to assist non-expert ML users to partake in machine learning applications offers much value and time savings. The service may also learn from past data preparation operations requested by many different users for the same or similar ML applications and apply the learnt knowledge to autonomously configure and recommend future data preparation operation requests for the same or similar ML application. In one aspect, the disclosure can provide a method for an intelligent data preparation service to: receive configuration information from a service provider to configure the data preparation service; receive configuration information from a user such as output requirements for the data processed by the data preparation service; receive data inputs for data preparation; combine data inputs into a dataset and generate metadata for the features of the dataset and dataset context information; analyze the data inputs, feature metadata and dataset context information to derive recommended data preparation operations; send recommendations to the user including one or more data preparation operations the service suggests be performed on the data; receive a reply to the recommendations from the user including consent from the user for the service to perform one or more suggested operations and then performing the one or more operations on the dataset; and, using user output requirements, service provider configurations, feature metadata, dataset context information, and any recommendation responses from the user: perform feature engineering to select appropriate features to meet the user output requirements; and configure the service to clean, synthesize, transform, label, and divide the dataset for the training, validation, and test of a model or algorithm for ML applications.

In another aspect, a method for an intelligent data preparation service is described to: receive configuration information from a user such as output requirements for the data processed by the data preparation service; generate and store feature metadata and dataset context information regarding data preparation operations performed on the datasets of different users by the data preparation service; train one or more ML models of the data preparation service using the generated feature metadata and dataset context information; use one or more trained ML models, data inputs, and user configuration, to infer which data preparation operations to perform on which datasets and for which users, thereby reducing the amount of user configuration and interaction required with the data preparation service; and generate configurations for enhancing the data preparation service, including providing recommendations to users of the appropriate operations for data preparation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

FIG. 1 depicts an architecture for intelligent data preparation service.

FIG. 2 depicts a data preparation call flow.

FIG. 3 depicts an example graphical user interface (GUI) for service configurator configuration.

FIG. 4 depicts a service configuration call flow.

FIG. 5 depicts an analytics/machine learning (ML) function call flow.

FIG. 6 depicts an analytics/ML function support for synthesizing data.

FIG. 7 depicts a configuration of a data input function.

FIG. 8 depicts a data input call flow.

FIG. 9 depicts a configuration of a data clean function.

FIG. 10 depicts a configuration of a data synthesizer function.

FIG. 11 depicts a configuration of a data transform function.

FIG. 12 depicts a configuration of a data labeler function.

FIG. 13 depicts a configuration of a data output function.

FIG. 14 depicts a data preparation report and visualizer call flow.

FIG. 15A depicts an example communications system in which the methods and apparatuses described and claimed herein may be an aspect of;

FIG. 15B depicts a block diagram of an example apparatus or device configured for wireless communications;

FIG. 15C depicts a system diagram of an example radio access network (RAN) and core network;

FIG. 15D depicts a system diagram of another example RAN and core network;

FIG. 15E depicts a system diagram of another example RAN and core network;

FIG. 15F depicts a block diagram of an example computing system; and

FIG. 15G depicts a block diagram of another example communications system.

### DETAILED DESCRIPTION OF ILLUSTRATIVE EMBODIMENTS

Machine learning is the process of providing data for a specific application to train an algorithm or model to learn of a desired behavior for use in future inferencing. The process includes identifying data for the application, collecting and preparing the data, training an algorithm or model with the clean data, validating and testing the trained model, deploying the model for inferencing, and monitoring the operations of the model. A critical step of the ML process is the data identification and preparation steps which directly impact how well the ML model will perform as ML operations are entirely dependent on the data that are used to train, validate, and test the model.

Much time is spent and required from domain experts and/or data scientists to properly prepare data to ensure the input data are clean and in the proper format for the ML algorithm or model. As such, data preparation for ML application is a tedious and highly repetitive process that has predominantly been the domain of data scientists and engineers. In addition, there is a dizzying array of operations that may be performed on the data to merge, clean, transform, synthesize, and label the data. Furthermore, there is also a wide selection of machine learning algorithms and models to choose from and each may have certain requirements on the input data that a typical user may not be aware of. As a result, data needs to be cleaned and transformed into a certain format, type, value, and/or representation in order for the algorithm or model to be properly trained to provide the desired inferencing accuracy.

### Intelligent Data Preparation Service

An approach to making the machine learning data preparation process easier for non-ML expert users is to provide a service that guides the user step by step through the ML data preparation process or workflow. This guidance may involve the service performing data transformation operations on behalf of the user in an automated manner based on the service's ability to learn which data preparation operations to perform on a targeted dataset of a particular ML application. The service may also rely on interacting with a user to obtain additional insight and/or consent to perform data preparation operations recommended by the service. For example, the service may make recommendations to a user regarding suggested data preparation transformations to perform, receive consent from a user that it is OK to perform the transformations, and then perform the transformations on behalf of the user. As another example, the service may obtain user insights during data labeling and may apply the knowledge gained from the insight to automate labeling the rest of the dataset that is similar to the current data instance.

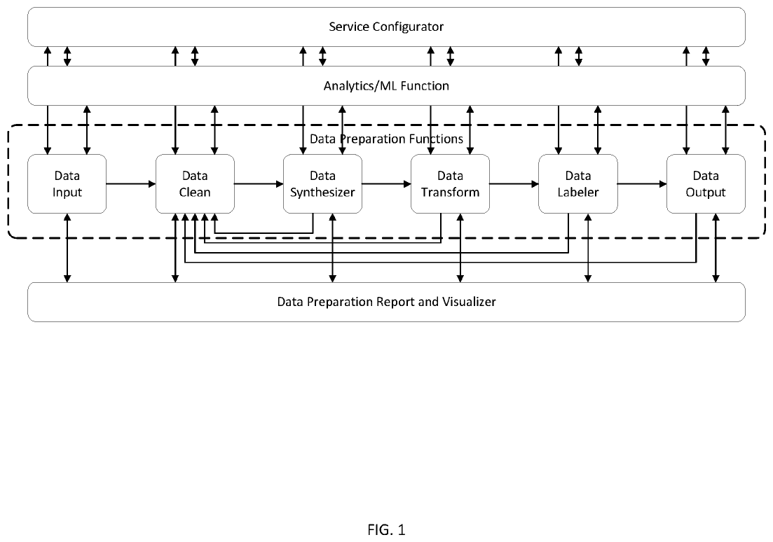

An example of an architecture providing this level of support and guidance is proposed in FIG. 1 where the intelligent and automated data preparation service is divided into multiple functions that focus on manageable and understandable operations. The service may support a Graphical User Interface (GUI) and/or an Application Programming Interface (API). In turn, each function of the service may be accessible through the graphical user interface or API call with required parameters. The GUI/API may be presented to enable users to observe as well as control the overall data preparation process supported by the service. The GUI/API may also allow users to select and configure the individual functions within the service that focus on the desired data preparation tasks. Each function may offer suggested configurations for a particular task that the user can then customize the details of.

The service as well as the individual functions may also support observing data preparation operations selected and performed by individual users on their respective datasets. Based on these observations, the service and its functions may detect (i.e., learn) patterns or user preferences of data preparation operations performed by different users on different datasets and tasks. Based on these learned patterns and preferences, the service may provide further automation to its users. For example, the service may automatically configure itself and its individual functions when detecting a particular user or dataset such that certain settings are applied to the data preparation operations and the operations are performed on the dataset by the service. This can alleviate users of the burden of having to configure all aspects of the data preparation service and its functions to perform certain data preparation operations. Instead, the data preparation service can self-configure itself and perform these operations automatically on behalf of the users, e.g. based on user preferences and requirements. This can save users time as well as simplify data preparation operations (e.g., especially for novice ML users).

The architecture of FIG. 1 shows an example configuration provided by a data preparation service. The service may include support of data preparation functions as shown in the figure to break down the complexity of the data preparation process into simpler, understandable components. The service may also include configuration and management functions for the service as well as a reporting and visualization component for user interaction with the service. The data preparation functions may consist of Data Input, Data Clean, Data Synthesizer, Data Transform, Data Labeler, and Data Output functions. The selection and order of the functions may be organized by the user based on their data preparation requirements or preferences. Alternatively, the data preparation service may recommend the selection and order of the functions (e.g., based on learned selection and ordering of functions selected for different ML application types of different datasets). Each of the functions will be described in further detail hereinafter. In addition, there may be various ways that the service (and each of its functions) may be configured. For example, configuration and interaction from the user, through service provider configuration, autonomously using analytics or machine learning capabilities, or a combination thereof. Finally, the Data Preparation Report and Visualizer function of the service may provide users visibility into the data preparation operations performed by the service. This enables users to better understand how the data is being prepared throughout the data preparation process, including the intermediate processing within each function.

Note that configurations may be provided by the user, from the analytics/ML capability of the service, and from the service provider itself. The service provider configurations may be based on well-known ML data preparation functions and/or operations that may be applied to all users. Analytics/ML configurations may be generated based on learned behaviors of past data preparation workflows from different users. User configurations may be specified by a user of the data preparation service to provide domain specific knowledge for the ML application. Note also that the configurations may not only specify the sequence and order of data preparation functions but also the sequence and order of the operations within each of the data preparation functions. In addition, configurations may specify parameters that are used by the individual operations and also to control the entire data preparation workflow. As examples, configurations may specify the minimum number of samples for a dataset, the maximum number of features for a dataset, the target feature of the ML application, a reporting level, etc.

The Service Configurator function provides a mechanism for users to input domain specific knowledge and other requirements for data preparation. For example, the user can identify requirements for the data preparation such as the targeted features for inferencing and a list of input features that are desired for the ML application. The user may also specify domain knowledge about certain data inputs such as the data types and formats, data ranges, data enumerations, applicable data transforms, and how data output is generated and presented. Furthermore, the user may include rules that may be used for synthesizing and labeling data or to specify a particular transform function. The user configuration may be targeted towards one or more specific functions of the service or targeted to the overall service and applied throughout the data preparation process.

The Service Configurator may also provide the capability to share with users recommendations regarding suggested data preparation operations to perform on a dataset. These recommendations may be data preparation operations the service has observed (i.e., learned) being performed on datasets of similar ML applications in the past via the service. In turn, the Service Configurator function may also provide the capability for a user to respond to a recommendation it receives from the service. Within a response, a user may provide its consent to the service to perform one or more data preparation operations and in a particular sequence. The user may also provide additional information such as further instructions (e.g., filters specifying which features in a dataset to apply a data operation on or one or more transformation operations to apply to a dataset). Based on this response, the service may then determine if/how to perform one or more recommended data preparation operations on the dataset on behalf of a user. Additionally, the Service Configurator may also make recommendations based on learned behavior of data preparation operations performed by the same or another user in the past. The learned behavior of users may be stored as user preferences upon which recommendations are based on.

In addition to user configurations, the data preparation service may also be updated with service provider configurations. For example, the service provider may upgrade the service based on emerging ML developments such as a new data transform function or data labeling feature that users are requesting the service to support. These service provider configurations may be exposed to the user of the service (e.g., via a configuration discovery mechanism and/or a recommendation/notification mechanism supported by the service) for inclusion into their data preparation work flow. The user is then able to determine whether to incorporate the configuration into their data preparation workflow.

Another source of configuration may be driven by analytics or machine learning capabilities that are incorporated into the service. One or more analytics or machine learning models may be used by the service (and/or one or more of its individual functions) to learn about the usage of the data preparation service by different users, different ML applications, and/or data preparation operations targeting different types of datasets. Within the service, functionality may be incorporated to collect information regarding the data preparation operations as they are performed by the service. This information may then be used to train/re-train analytics or ML models deployed within the service. Using these analytics or ML models, the service may generate configurations based on the learned behaviors that may be used by the service to configure and automate subsequent iterations of data preparation workflow it performs on behalf of users. For example, the configurations may be used by the service to automate the configuration of the sequence and order of data preparation functions and the types of data preparation operations that are performed for a particular user, ML application and/or type of dataset. Examples may be how input data are identified, combined, and with what formats. Other examples are how data are cleaned relative to the dataset size or what data ranges are appropriate for a particular feature. Identification of the feature and the associated metadata may be another example of how analytics/ML configurations may be used to improve the data preparation workflow provided by the service. For some instances such as data synthesizing and labeling, especially for well-known ML applications, analytics/ML configurations may be utilized as well. For object classification applications, the Analytics/ML function may autonomously use analytics/ML models specializing in object detection to identify objects in an image or video. The service may further use another ML model to group the detected objects and with user configurations or interactions, the service may also be able to label the objects.

The Data Preparation Report and Visualizer function may be made available to the user for each function of the service to provide insight with how the data is being processed. Reports may be generated at the output of each function as well as at the output of intermediate operations within each function. The service may also be able to provide visualization graphics and APIs to show the relationship among the different functions and their features, e.g. to show the before and after processing of the data. The Report and Visualizer function may also provide recommendations suggesting additional and/or modified data preparation operations that the user may want to consider to further clean or improve a dataset. The Report and Visualizer function may also support the capability for a user to provide a response to a recommended data preparation operation (e.g., provide consent or instructions for the service to perform one or more suggested data preparation operations).

Another aspect of the architecture shown in FIG. 1 is the available feedback paths between the individual functions of the service. These feedback paths enable the flexibility of iterating through certain data preparation functions for multiple iterations while preserving the separation and grouping of tasks to simplify the data preparation process into manageable steps. As an example, data may require cleaning after new data are synthesized, transformed, labeled, or as a final check at the output. Using the feedback paths, any latter function is able to provide feedback to an earlier function such that earlier functions can reiterate on the data if needed. The service may automate when the feedback paths are triggered and enabled.

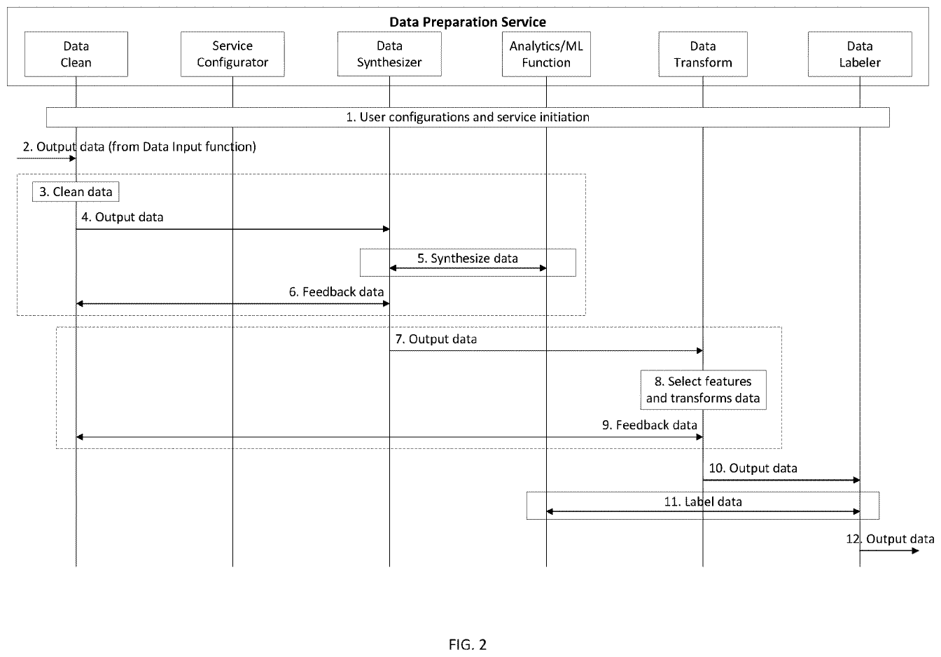

An architecture such as the one shown in FIG. 1 may provide flexibility for how data preparation may be managed. An example call flow showing the flow of data through the service may be envisioned in FIG. 2. The start of the call flow in this example begins at the output of the Data Input function after a dataset has been generated from one or more input data sources. A user may have provisioned the data preparation service with output requirements and other user configurations prior to initiating the service. The call flow may continue within the data preparation service from the Data Clean function, through the Data Synthesizer and Data Transform functions, and out to the Data Labeler function. Data would then flow to the Data Output function, which is not shown in FIG. 2. It is worth noting the example call flow of FIG. 2 is just one configuration of the proposed Data Preparation Service in which a user or the service may configure. Other configurations may be envisioned to use one or more functions as shown in FIG. 1 depending on the requirements of the ML application. Note that the example of FIG. 2 may not show all the interactions between functional components of the data preparation service. For example, the Data Clean, Data Synthesizer, Data Transform, and Data Labeler functions may communicate with both the Service Configurator and Analytics/ML Function when processing the dataset. Information such as feature metadata and dataset context information may be shared and updated by each of the functions and included with the output data. In addition, the Service Configurator and/or Analytics/ML Function may make configuration or processing recommendations to the user to assist with the data preparation workflow.
Step 1: A user may provide the Data Preparation Service (e.g., via the Service Configurator) with output requirements and configurations and may have also initiated the data preparation service. As part of initiating the service, the user may have identified one or more data input sources. The user output requirements and configurations may inform the data preparation service on what functions and operations the ML application may need. As a result, the service may generate a workflow as shown in the figure to guide the user along the data preparation process. The service may also provide recommendations to the user (and receive responses back from the user) regarding suggested data preparation operations to perform on the dataset. These recommendations may be data preparation operations the service has observed (i.e., learned) being performed on the same or similar datasets for similar ML applications in the past via the service.
Step 2: The one or more data input sources may have been processed by the Data Input function, which is not shown in the figure, and the Data Input function may output a dataset to the Data Clean function in this step. In addition, the Data Input function may generate feature metadata and dataset context information that may assist the Data Clean function and other data preparation functions identified by the figure with preparing the data. The service may even use the feature metadata and dataset context information to make recommendations on the configuration of the individual functions, e.g. what data preparation functions are required, the sequence of operations for each function, and whether feedback iterations are required.
Step 3: A Data Clean function may clean the data of the dataset as described hereinafter. The Data Clean function may remove duplicate data from the dataset, perform data range checks and outliers in the data, handle structural errors and perform string conversions on categorical data, and detect similar data and perform cross validation checks of the dataset. Some feature engineering may be performed at this function to remove redundant or similar features that may arise from data combining. The Data Clean function may also update the feature metadata and dataset context information to inform downstream functions of processing that have been applied to the dataset.
Step 4: Once data have been cleaned, the dataset may be sent to the Data Synthesizer function to synthesize data that may be missing from different features and/or possibly insert synthetic data instances if the coverage of the dataset is low. The output may include the feature metadata and dataset context information that may assist the Data Synthesizer with its task.
Step 5: The Data Synthesizer function may interact with the Analytics/ML function in synthesizing the data, possibly using learned behaviors from previous usage of the Data Preparation Service by the same user or for the desired ML application type. The data synthesis may be performed individually on a feature or collectively for the dataset. The Data Synthesizer function may also update feature metadata and dataset context information to inform downstream functions of synthetic data that have been added to the dataset.
Step 6: If necessary, the Data Synthesizer function may provide feedback data to the Data Clean function to check the dataset on whether any synthesized data may need to be cleaned further. Steps 3 to 6 may be performed over multiple iterations until all the data in the dataset meet the output requirements as specified by the user. The service may have autonomously configured the feedback mechanism during step 1 after the initiation of the data preparation service based on learned behaviors of past iterations of the data preparation service, e.g. using statistics that indicate a high percentage of previous data preparation iterations may require data cleaning after data synthesis.
Step 7: After the dataset have been cleaned and synthesized to meet user output requirements, the dataset may be sent to the Data Transform function. Note that any processing information generated from steps 3 to 6 may be included in the feature metadata and dataset context information for use by downstream functions of the data preparation service. For example, identification of synthesized data may be added to the metadata for features that may have had missing data as well as information added to the dataset context information for synthesized data instances. Other examples may include cleaning information applied to certain features or to the entire dataset.
Step 8: The Data Transform function may perform data transformation of the dataset on one or more features. This step may select the appropriate feature and perform a corresponding transform on the data of that feature. The step may iterate for all features that may require data transformation as specified by user output requirements, one or more configurations (e.g. service provider, user, and/or analytics/ML), or based on feature metadata and/or dataset context information, or a combination thereof.
Step 9: Similar to step 6, the Data Transform function may provide feedback data to the Data Clean function to determine if the transformed dataset may need to be cleaned. This step may be repeated for multiple iterations as well to ensure the output of the data transformation process is clean and meets the user output requirements.
Step 10: When the dataset have been transformed for all specified features, the dataset may be outputted to the Data Labeler function. This particular example may target a supervised learning application which requires labeled data and the Data Labeler function may provide the necessary mechanism to label the dataset. The Data Transform may also provide updated information, in either the feature metadata or the dataset context information, or both, to the Data Labeler function.
Step 11: As will be described hereinafter, the Data Labeler function may label the dataset using rules-based labeling, analytics/ML labeling, user interactive labeling, or a combination of the different mechanisms. The Data Labeler may interact with the Analytics/ML Function to perform the ML labeling. The Analytics/ML Function may have learned from previous use of the function to assist with the labeling or it may offer object recognition that may streamline the labeling process. Similar to the other functions, the data labeling function may also iterate many times until all the data instances have been labeled. It is assumed in the example that the labeling of the data is in the correct data type and format. If this is not the case, then the dataset may need to be cleaned and transformed using the feedback mechanism of the service. Note these steps are not shown in the figure.
Step 12: Finally, the complete dataset may be ready to be sent to the Data Output function, which is not shown in the figure, once all the labels have been applied and the dataset have been checked. The Data Labeler function may add metadata to the labeled feature and other information to the dataset context information to assist with interpreting the labels if it is not obvious from the provided metadata.

Another important note to FIG. 2 is the Data Preparation Report and Visualizer function is not shown for brevity as it is shown in FIG. 1. Each of the functions shown in FIG. 2 may indeed provide reporting and other information to the Data Preparation Report and Visualizer function to document and highlight the processing being performed throughout the data preparation process and made available to the user. The information may highlight pertinent processing that a user may find interesting or need to validate or verify. It may also include statistics and visualizer aids for the user to see for example how data is cleaned or transformed. The information may further show synthesized or labeled data that the user may need to confirm and validate.

Note that in the following description of the functions of the data preparation service, many examples are shown of possible configurations for the individual functions. These examples are by no means to limit what and how each function can be configured. In addition, examples of operations may be shown in various configurations and the same operation may even appear in multiple functions due to the iterative nature of data preparation for ML applications. The configurability of both functions and operations as well as the sequence of each may be customized to suit a user's data preparation needs. The service may provide initial configurations for each function based on user configurations and update the configurations based on the analysis of the dataset by each function. Therefore, the configuration of each function may dynamically change during the data preparation process based on data analysis and user interactions with the service. Note that the terms “workflow” and “process” are used interchangeably to refer to the entire data preparation procedure.

### Service Configurator Function

The Service Configurator function allows for extensibility of the data preparation service by providing a mechanism to update the service through either user or service provider configurations. A configuration may be provided to identify what data preparation function(s) the configuration applies to, what types of ML application the configuration is suitable for, what triggering condition(s) the service is to detect, and what applicable processing to apply to the data.

The Service Configurator function may also provide the capability to share recommendations with users regarding suggested data preparation operations to perform on a dataset and to receive feedback from users regarding which suggested data preparation operations they would like the service to perform on their behalf.

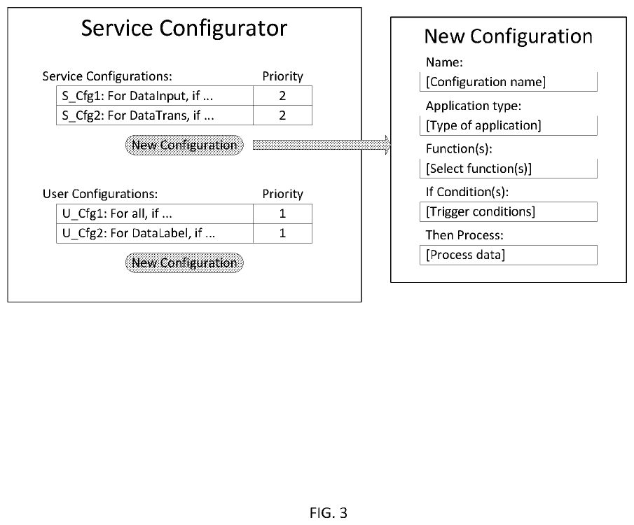

FIG. 3 shows an example Service Provider Configurator GUI where a user or service provider may request to create a new configuration. The user or service provider may include information in the request to create a new configuration via an API or via a second GUI to input the configuration when prompted by the service. The data preparation service may provide GUI options for specifying the name of the configuration, an entry for which function the configuration applies to, the type of ML application the configuration is suitable for, the triggering conditions that activate the configuration and the resulting processing that occurs to the data. Alternatively, a Service Configurator API (e.g., RESTful or command line API) supporting comparable functionality as the functionality of the GUI shown in FIG. 3 may be used instead. For example, a user or service provider may send one or more requests using a RESTful Service Configurator API comprising one or more resources used to create, update, retrieve or delete a user or service provider configuration.

The main Service Configurator GUI of FIG. 3 shows an example of a listing of the service provider and user configurations with the corresponding priority and an option to create new configurations for each type of configuration. The priority of a configuration may inform the service of the sequence of evaluation, should two or more configurations overlap each other and/or have the same triggering conditions and/or processing tasks. Typically, a user may designate that user configurations are higher priority as it may have domain specific knowledge that a service provider configuration may not have. The service provider configuration may be used to update the service with configurations obtained from other users of the service for common functionalities that can benefit other users such as a new data transform function, new or updated feature metadata definitions, and new service capabilities. Note that domain knowledge may be incorporated with the service provider configurations as well if a user can benefit from the addition.

When creating a new configuration, a user may specify a name to identify the configuration. The service may associate the name with an internally generated identifier so the configuration may be referred to and reuse in other data preparation requests. The identifier may be globally unique within the service or only unique on a per user basis.

With user configurations, users may provide domain knowledge of the desired ML application to the data preparation service. The user configuration may be specified to describe the ML application type, the triggering conditions for which the configuration applies to, the resulting processing of data when triggered, which preparation functions should activate the configuration, and a name to identify the configuration. For other user configurations, the user may also specify output requirements for use in data preparation to assist the service with processing the data. These requirements may specify the features of interest including the targeted features for the ML application (e.g. used in supervised learning applications), the enumeration of data inputs, the identification and metadata of data types, specific cleaning operations, information for synthesizing data, transform functions for identified data types, labeling rules, whether autonomous operations are desired, what feedback the user requires, etc. To specify user output requirements, the Function(s) parameter may be configured with “Output requirements”, “General functions”, or some other designation to inform the data preparation service that the configuration applies to all functions and operations of the data preparation process. Alternatively, the service provider may provide a different GUI from the one shown in FIG. 3 for users to specify other requirements that may impact the data preparation process. An example of information that may be found in user configurations is shown in Table 4.

The Application type parameter may be specified in various ways to indicate what ML application(s) the configuration may apply to. One approach may be general types such as supervised and unsupervised learning typed applications while another approach may be types of machine learning applications such as classification, regression, and clustering. Other approaches to classify application types may be single and multiple object detection and recognition, numerical forecast, pattern recognition, dimensionality reduction, etc. Yet another approach may be industry specific such as insurance, banking, finance (e.g. stock market), environmental (e.g. meteorology, seismology), bio-pharmaceutical, automotive, etc. If a configuration may be applicable to all ML applications, then an application type of “General” may be specified. The ML application type may be used by the data preparation service with making recommendations for data preparation configurations and operational sequence. The data preparation service may learn from past usage of different users for the same or similar ML application type of the processing configurations used and apply that knowledge in making recommendations for future usage of the service for the same or similar ML application.

The Function(s) parameter may be used to specify what data preparation function(s) this configuration applies to. If the configuration may be applied to several functions, e.g. Data Input and Data Clean, then the Function(s) parameter may be a list that includes both function names. If the configuration may be applied to all the functions, the Function(s) parameter may be specify as “all” or “general” to indicate to the service to apply the configuration to all the processing functions. A good example of this usage is if the configuration contains definitions and/or metadata for a data type and may be applied to all functions in the data preparation process.

Next, the Condition(s) parameter may be used to define the triggering condition(s) that will trigger the service to perform the corresponding processing specified in the Process parameter of the configuration. The condition parameter may be used to identify a data type, a range of values for a feature, as part of a data labeling rule or to specify the conditions for synthesizing data, etc. The Process parameter is the action that the service performs based on the triggering of the Condition(s) parameter. The Process parameter may be a function that combines data together or removes a feature or dataset sample, to generate missing data or to synthesize a dataset sample, to transform a feature from one format to another format, to apply some mathematical or custom function on the data, etc. A part of the Process parameter may also specify if the action is performed on vector or scalar data.

Both the service provider and user configurations allow the data preparation service to be extensible and configurable to learn the usage of the service for customizing the service to the user's needs. Service provider configurations may be applied to general data preparation of many different ML applications while user configurations may be applied to more specific ML applications the user is targeting. The service provider configuration may also be used to introduce new features to the service, e.g. to incorporate new ML data processing functionalities. For some instances, it may make sense to configure a user configuration as a service provider configuration for the user to customize the service to apply the configuration to ML applications the user initiates data preparation for. As an example, a user configuration that applies to multiple application types may be used as a service provider configuration for all user initiated services with the identified ML application types. Alternatively, a user configuration specified with a “General” application type may be applied to data processing of all ML application types. The data preparation service may identify user configurations that may also apply to different ML applications as service provider configurations. The combination of the service provider and user configurations may be saved per user to customize the data preparation service for individual users.

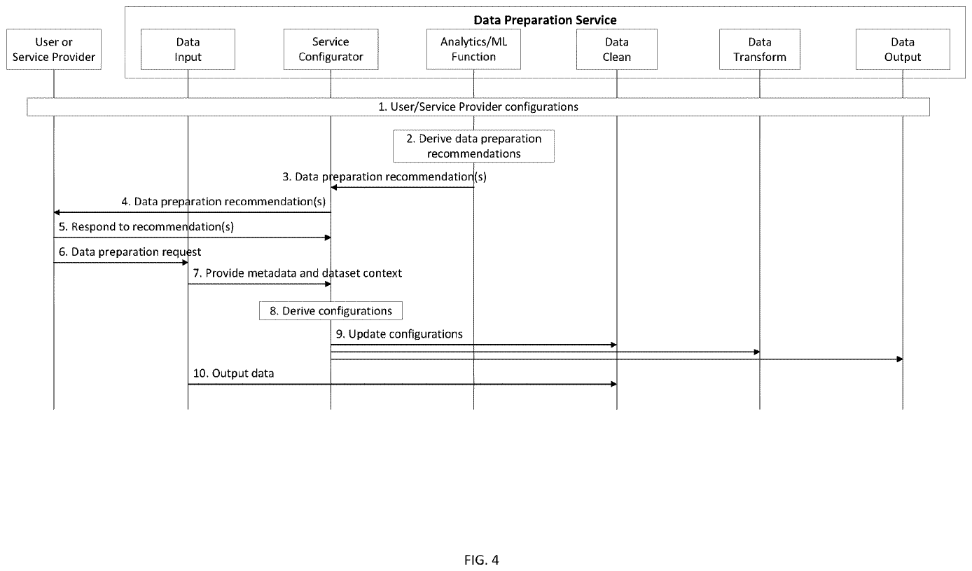

In addition to supporting configuration requests from users and service providers, the Service Configurator function may also support the capability to share recommendations with users regarding suggested data preparation operations to perform on a dataset. These recommendations may be data preparation operations the service has observed (i.e., learned) being performed on the same or similar datasets for a particular ML application. In turn, the Service Configurator function may also provide the capability for a user to respond to a recommendation it receives from the service. Within a response, a user may provide its consent to the service to perform one or more data preparation operations recommended by the service. The user may also provide additional information such as further instructions (e.g., filters specifying which features in a dataset to apply a data operation on or one or more transformation operations to apply to a dataset). Based on user feedback, the Service Configurator function may derive and update configurations of other data preparation functions within the service such that they perform the one or more recommended data preparation operations on dataset(s) on behalf of the user. An example showing the operations of the Service Configurator and Analytics/ML functions providing recommendations to the user is shown in FIG. 4.
Step 1: A user may provide the data preparation service with output requirements and configurations for a particular ML application. The output requirements and configurations may include the ML application type and information on what functions and operations the user may need and whether autonomous operation is desired. As a result, the service may generate a workflow as shown in the figure to guide the user along the data preparation process. For this particular example, the user may be preparing data for an unsupervised learning application and therefore, may not require the Data Labeler function. The service may then generate configurations for the Data Input, Data Clean, Data Transform, and Data Output functions. At this point, the service may not know whether the Data Synthesizer function is needed as a dataset has not been created yet. The user may also provide the service with contact information (e.g., URL, IP address and port) which the service may use to send configuration recommendations to the user. The service may provide information back to the user such as one or more identifiers of user configurations created and/or stored by the service and/or information (e.g., URLs of APIs) that the user may use to send data preparation requests to the service.
Step 2: Based on user requirements and configuration information, the Analytics/ML function may derive (i.e., infer) data preparation recommendations for the user such as one or more configuration settings and/or data preparation operations to perform on behalf of the user. The Analytics/ML function may have learned from past data preparation workflows for a particular ML application that matches the current ML application type and makes the recommendations based on the learned behavior. Additionally and/or alternatively, the learned behavior may be based on past usage of the service by the user.
Step 3: The Analytics/ML function may send a data preparation recommendation request to the Service Configurator function such that it can be shared with the user. The Service Configurator function may use the recommendations to generate initial configurations for each of the data preparation functions.
Step 4: The Service Configurator may send the data preparation recommendations to the user. The recommendations may include information regarding the one or more suggested configuration settings and/or data preparation operations the service can perform on behalf of the user. If the user had configured the service for autonomous operation in step 1, the Service Configurator function may wait for the user to request data preparation service in step 6 and apply the recommendations provided by the Analytics/ML function to derive the configurations specified in step 9.
Step 5: The Service Configurator function may receive a response from the user regarding the data preparation recommendations. The response may include information such as an indication whether the user gives their consent to have the service perform the recommended data preparation operation and/or configuration setting update on their behalf. The response may also include additional information such as configuration settings and/or qualifiers (e.g., filters, instructions, parameters) that the service uses to further qualify if/how/when/what recommended data preparation operation(s) it performs on behalf of the user.
Step 6: Data preparation request(s) from the user are received by the Data Input function of the service. Each request may include information such as a target address of the service (e.g., URL of the Data Input function of the service), raw user/application data to be processed by the service, metadata describing the raw data (e.g., data schema or link or identifier of a data schema), user information (e.g., identifier of the user), user configuration information (e.g., identifier of a user configuration stored by the service). Note, the raw user/application data may be included inline within the request itself or alternatively, the request may include one or more identifiers or addresses of data sources or data storage locations where the data can be accessed from.
Step 7: The Data Input function may receive and process the input data within the request(s) from the user. After the Data Input function has completed processing the input data, the generated feature metadata and dataset context information may be sent to the Service Configurator function.
Step 8: In response to receiving the feature metadata and dataset context information, the Service Configurator may use the information in conjunction with the recommendations provided by the Analytics/ML function from step 3 to derive configurations for the remaining functions. Alternatively, the Service Configurator function may use the information to update existing configurations of the remaining functions if initial configurations were previously generated in step 1 or after step 3. New information about the dataset may have been received and adjustments to the operations for the remaining functions may be made at this time.
Step 9: The Service Configurator function may notify the remaining functional blocks of the new or updated configurations. In this particular example, the Dataset Analyzer operation within the Data Input function may recognize that there is no missing data and the dataset has sufficiently large number of data instances and therefore, the data preparation workflow may not need to include the Data Synthesizer function. The configurations may contain industry specific cleaning and/or transform operations that may be required. If the data preparation service does not have such a function, the service may need to communicate with an external entity to retrieve such information from the external function. If the clean or transform function exists within the service, e.g. in an internal repository, the service may enable the performing of that operation. Alternatively, the service may be directed to communicate to an external entity to perform the clean or transform function.
Step 10: The dataset, feature metadata, and dataset context information may then be sent to the next processing function of the data preparation workflow, which is the Data Clean function in this example. The Data Input function may wait for a response from the service provider configurator that new or updated configurations have been provided to the remaining functions before sending the dataset and related information to the next processing function. The data flow continues from the Data Clean function to the Data Transform and Data Output functions. For brevity, these steps have not been shown in the figure.

### Analytics/Machine Learning Function

The Analytics/Machine Learning (ML) function provides the data preparation service with the ability to learn such that the service can recommend customized configuration and data preparation operations for different ML applications and datasets. The Analytics/ML function may support the capability to monitor and collect information from each of the functions within the service as they perform the requested data preparation operations on different datasets from different users. The Analytics/ML function may use this collected information to analyze the information or train machine learning models supported by the data preparation service. The machine learning models can then be used by the data preparation service and its individual functions to make recommendations regarding how to configure the service and what data preparation operations to perform on a given dataset for a given ML application. By doing this, the data preparation service can be further automated such that the level of configuration and interaction required between the user and the service can be minimized. For example, ML models may recognize the different types of representation and format of data for dates and the corresponding processing as learned from previous usage of the service. Using this information, the Analytics/ML function may provide recommendations for the different functions, such as the Data Clean and Data Transform functions. Other examples may include but are not limited to how data are combined, what feature metadata may exist for a particular data type, what data ranges exist for certain features, what data enumerations to apply, what functions to synthesize data with, how to map data, etc.

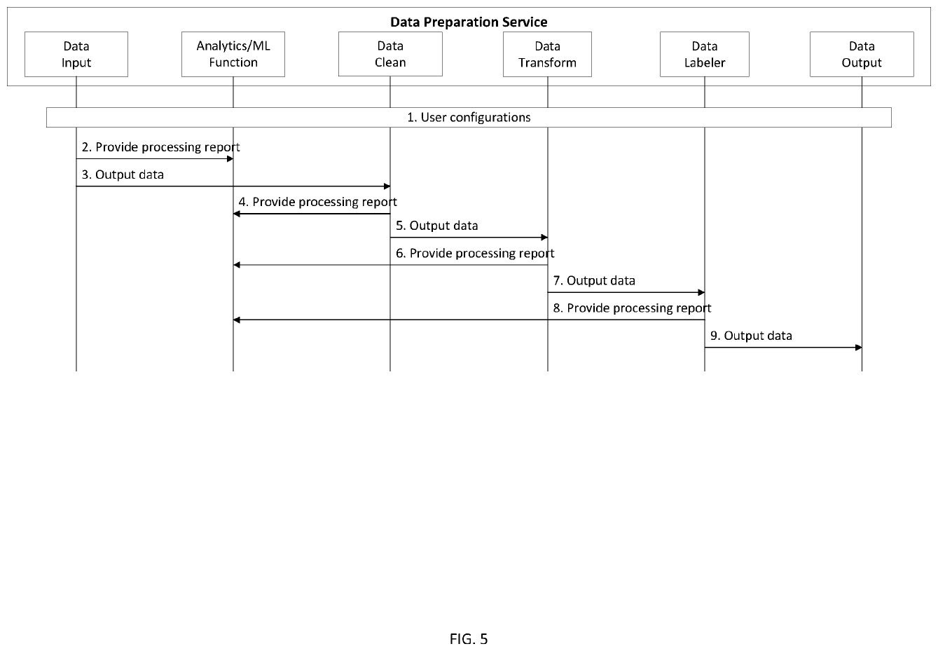

In addition to using information learned from previous usage of the service to automate user configuration and data preparation operations, the Analytics/ML function may also use the information to automate the generation of service provider configurations. The service provider configurations may be user specific or applied generally to all users. For example, a service provider configuration describing a common data transform may be applicable to general users of the data preparation service while a data transform for a vertical specific industry may be applicable to the user or users of the specific industry, e.g. such as banking, finance, environmental, automotive, sports, etc. An example of the interactions between the Analytics/ML function with other data preparation functions is shown in FIG. 5. The example shows how each of the data preparation functions provide the Analytics/ML function processing reports, which could then be correlated and tracked with earlier processing in the workflow to learn of data preparation behaviors for the same or similar application types to generate future recommendations.
Step 1: As part of initiating data preparation service, a user may provide configurations for a desired ML application and may have also identified sources of input data. As a result, the Service Configurator function, which is not shown in the figure, may generate configurations for each of the data preparation functions to process the data. The Data Input function may have combined the input data sources into a training dataset based on the output requirements specified by the user configurations and extracted metadata and context information from the input data.
Step 2: The Data Input function may provide the Analytics/ML function with the combined dataset, feature metadata, and dataset context information extracted from the input data. The Analytics/ML function may utilize the information to identify the dataset as the initial state of the data preparation process. For example, the Analytics/ML function may note the features of the dataset and their corresponding data format so it may track how the data is processed by subsequent data preparation functions.
Step 3: The dataset generated by the Data Input function may be sent to the Data Clean function for further processing. In addition, the feature metadata and dataset context information are included with the output data to provide additional information to assist the Data Clean function.
Step 4: The Data Clean function may perform the operations according to the configuration from the Service Configurator function and information received from the feature metadata and dataset context information. The Data Clean function may generate a processing report to send to the Analytics/ML function for analysis. The processing report may include the dataset, feature metadata, dataset context information, and other processing information on operations the Data Clean performed on the dataset. The processing report may be sent in real time or after completion of all the operations. Additionally or alternatively, the processing reports may be made available for the Analytics/ML function to retrieve for analysis. The Analytics/ML function may compare the processing report against the initial state of the dataset to identify what processing has been performed on the data. The Analytics/ML function may note the changes and save the observations for future reference. Note the user had provided configurations to the service in step 1 identifying what ML application type this data preparation request is targeting. The Analytics/ML function may associate the observations with the ML application type. In the future, if the same ML application type is requested, the service may then apply the observations as recommendations to the configuration of that request. The Analytics/ML function may also save state information about the dataset for comparison with the next processing report received from downstream functions.
Step 5: After processing completes, the Data Clean function may send the output data and associated metadata and context information to the Data Transform function.
Step 6: Similar to step 4, the Data Transform function may provide a processing report to the Analytics/ML function. The processing report may be sent in real time or after completion of all the operations. Once again, the Analytics/ML function may compare the state of the dataset with the previous saved state to identify the processing performed on the dataset. Additionally or alternatively, the Analytics/ML function may observe the processing information found in the processing report to identify what was done. During this step, the Analytics/ML function may gain knowledge of which data transformation operations are required for this particular ML application. For example, the Analytics/ML function may observe a certain feature has been transformed to another data format more suitable for the underlying ML algorithm or model. If a sufficiently large number of past data preparation workflows show that the same data transformation operation is performed on that particular feature, then the Analytics/ML function may use that knowledge to recommend the data transformation operation for that feature in future data preparation requests. Similar to step 4, the Analytics/ML function may also save state information about the dataset.
Step 7: Once all data transformations have been performed, the data output and all associated metadata and context information are sent to the Data Labeler function.
Step 8: The Data Labeler performs the required labeling operations for the dataset. During this step, some user interactions may be necessary if the labeling rules and any available ML rules are not sufficient to label all the data. A processing report is generated, especially noting the user interactions, and sent to the Analytics/ML function for analysis. The Analytics/ML function may analyze and track the user interactions for many data preparation iterations from different users to determine if patterns may be found from the data. The Analytics/ML function may incorporate machine learning to try to uncover the patterns. If patterns are found, ML rules may be generated for future labeling needs.
Step 9: When all data have been labeled, the output data and all associated metadata and context information are sent to the Data Output function.

The example procedure of FIG. 5 shows how each function of the data preparation service provides processing reports to the Analytics/ML function. The Analytics/ML function may use the processing reports to monitor changes in the dataset from one function to another function and from an operation within a function to another operation within the same function. The Analytics/ML function may also save state information about the dataset after the processing of each function and/or operation to provide further analysis of changes to the dataset. Using both the information about the dataset and the processing reports from each function, the Analytics/ML function may utilize analytics or ML models to determine patterns in the data preparation process for different ML application types. The output of the analytics or ML models may be used to make recommendations for future data preparation workflows and/or to generate analytics/ML configurations for the service.

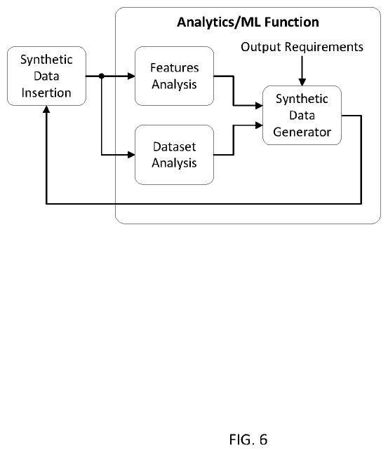

When synthetic data is requested, the Analytics/ML function may assist with generating the synthetic data. The Data Synthesizer function may communicate with the Analytics/ML function to identify gaps in the dataset that may require adding synthetic data. The Analytics/ML function may analyze the individual features of the dataset as well as the entire dataset to identify gaps in the dataset coverage as shown by the example configuration in FIG. 6. For example, a feature may have a data value range of 0 to 100 and the analysis may uncover that certain values in the range are not covered by the data for that feature. In addition, certain features may require an even distribution of values and the analysis may check that the data fulfills the distribution requirements. The Analytics/ML function may utilize analytics or ML models to determine and identify how to synthesize the data.

In addition to analyzing the features of a dataset, the Analytics/ML function may also analyze the entire dataset to determine if there are gaps in the data combinations among the features. Coverage of values within each feature may be complete but when the values are combined with values of other features, especially when the features list is large, there may still exist gaps in coverage. The Synthetic Data Generator operation may use information from both the features and dataset analysis as well as user output requirements to assist with generating synthetic data for the dataset. The user output requirements may provide configurations of optimization for synthetic data generation, such as efficient, exhaustive, percentage of dataset/features coverage, group of features requiring high coverage, etc. The optimization configuration may assist the Analytics/ML function to determine which combination of synthetic data may best be added to the dataset. As examples, the efficient optimization may indicate to add synthetic data selectively to improve the coverage while the percentage of dataset/features coverage may indicate to add synthetic data to achieve the desired percentage of coverage for the dataset/features.

Another function the Analytics/ML function may assist with the data preparation process is the labeling of data for certain supervised learning applications. The Analytics/ML function may use unsupervised learning models to cluster groups of data into two or more categories and coupled with user defined labels for each category, the Analytics/ML function may then autonomously label data in the same cluster as the user defined label for that category. In addition, the Analytics/ML function may also support object detection using available ML models within the data and provide information about the detected object as part of the data labeling operation.

### Data Input Function

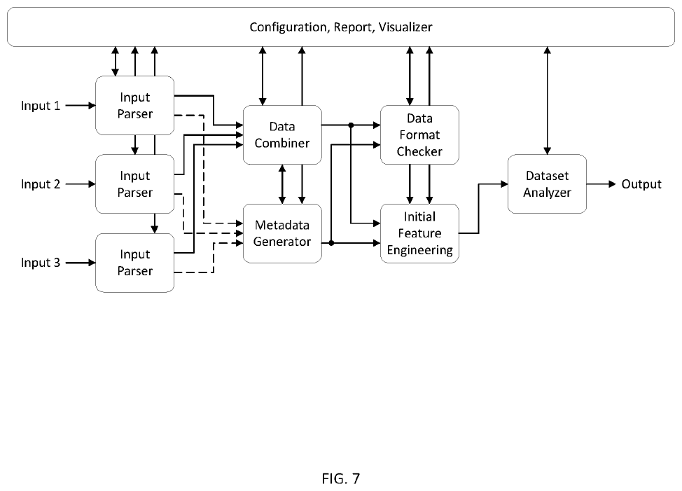

Prior to using the data preparation service, input data sources may need to be identified and made available. A user may provide the data preparation service with user configurations that contain information about the sources of input data and their location and the data preparation service may generate a data processing sequence of operations for the Data Input function as shown in FIG. 7. Once data sources have been identified, an Input Parser operation may parse the data to extract information about the dataset such as the targeted machine learning application and the characteristics of each feature. Some examples of information about a dataset may include the targeted machine learning application, the type and format of the data, the units associated with the data values, the range of the data values for a feature, the categorization of the data, information about relationships between and among the features, etc. If metadata exists or is provided for the features of the data source, the Input Parser operation may extract and send the information to the Metadata Generator operation for processing. The Input Parser may also utilize readily available configurations to assist with parsing the data, e.g. service provider configurations providing metadata for well-known features such date, time, currency, etc. Finally, the Input Parser may organize the data into tabular form to assist the processing of downstream functions of the data preparation service.

After the input data have been parsed, both the Data Combiner and the Metadata Generator operations may process the data in parallel. The Data Combiner may combine all the data in a lossless manner regardless of duplication of feature or only combine data as indicated by user or service provider configurations. Depending on the number of input sources, there may be features that are duplicated. As an example, if three input sources exist, there may be a common feature such as dates that may exist in each input source and therefore, the feature may be duplicated in the combined dataset. In addition, some features may exist in one or two input sources and each feature will be present in the combined dataset. For example, in a meteorology application, one data source may have date, temperature and humidity measurements; another data source may have date, temperature, and wind speed measurements; and a third data source may have date and a humidity measurement. The combined dataset may have as features: three dates, two temperatures, two humidity, and one wind speed measurements. The Data Combiner may automatically detect common features based on the features present from each data input or the features that appears the most in the combined dataset. An alternative to combining all the features in a lossless manner, the Input Parser may allow for selective combinations of the input data sources to avoid feature duplication. The user or service provide configuration may provide information of the desired features to select. This information may be provided by the user in advance (e.g., a user may create a user configuration within the data preparation service). Alternatively, this information can be collected by consulting with the user in real-time (e.g., a request may be sent to the user asking or recommending desired features for them to select from). When using the selectively features option, the user may need to ensure that the data source are aligned with each other when combined or let the service perform the alignment. The data preparation service may also offer autonomous data combining based on the analysis of the different input data sources. The service may use user/service provider configurations and/or recommendations from the Analytics/ML function as inputs or the Input Parser may perform analysis of each input source and determine common features between and among the different inputs.

Notice that in the combined dataset, there may be instances in which missing data is introduced by the Data Combiner operation due to unavailable data in one or more of the input data sources. As an example and shown in Table 1, certain dates in the aforementioned meteorology application may be missing in one data input source and not aligned with the other data input sources. When the data input sources are combined, the Data Combiner may not be able to resolve the missing data and leave the associate entry empty or provide some other indication that the data is missing. In addition, the Data Combiner may indicate in a report made available to the user that certain data instance(s) contain empty values as a result of combining the input data sources together. It is important to note that the introduction of missing data is a result of the data input sources and not made artificially by the Data Combiner operation. In fact, the Data Combiner is preserving the integrity of the input data in a lossless manner and in doing so, it is introducing the missing data. Another important note is that the Data Combiner may evaluate and combine the data at the feature level (e.g. column data of a table) as well as the data instance level (e.g. row data of a table). In other words, the Data Combiner may consider the combined data as a whole rather than individually in isolation when evaluating the dataset for missing data.

TABLE 1
Example of Combined Dataset with Missing Data

| Dataset #1 | | | Dataset #2 | | | Dataset #3 | |
|---|---|---|---|---|---|---|---|
| Date1 | Temperature1 | Humidity1 | Date2 | Temperature2 | Wind Speed | Date3 | Humidity2 |
| 7/21 | X1 | XX1 | 0721 | Y1 | YY1 | Jul 21 | Z1 |
| 7/22 | X2 | XX2 | 0722 | Y2 | YY2 | Jul 22 | — |
| 7/23 | X3 | XX3 | 0723 | Y3 | YY3 | Jul 23 | Z2 |
| 7/24 | X4 | XX4 | — | — | — | Jul 24 | Z3 |
| 7/25 | X5 | XX5 | 0725 | Y4 | YY4 | — | — |
| 7/26 | X6 | XX6 | 0726 | Y5 | YY5 | Jul 26 | Z4 |
| 7/27 | X7 | XX7 | — | — | — | Jul 27 | Z5 |
| 7/28 | X8 | XX8 | 0728 | Y6 | YY6 | — | — |

As indicated in FIG. 7, the Data Combiner operation may receive information from the Metadata Generator and conversely provide combining information to the Metadata Generator. As the Metadata Generator is processing the data, it may identify certain data are of the same type and notify the Data Combiner of this information. The Data Combiner may then use the information to determine common features that it can use to combine the data. The information may also assist the Data Combiner to combine data at the data instance level and detect whether the data input is missing data when combined together as shown in Table 1. The example of Table 1 shows that the common feature is the date inputs Date1, Date2, and Date3. Note that other features may be common when combining input data, such as customer ID, account numbers, investment options, car models, etc. The Data Combiner may make this determination based on evaluating the combined dataset to find redundant information, from user output requirements, from one or more service and/or ML configurations, etc. If configured for autonomous operations, the Data Combiner may remove the duplicate features from the dataset. The Data Combiner may also insert known enumerations such as NA for missing data to assist with the identification and processing of the dataset by downstream functions.

In addition to information that may be provided by the Input Parser, the Metadata Generator may extract additional information about each feature of the combined dataset. The Metadata Generator may extract the information from general knowledge of certain data types and from user, service provider, or analytics/ML configurations available to the service. Some examples of feature metadata that may be extracted are numerical or categorical representations, data formats and types, units of measurements, data enumerations, range of values, identification of data to specific industries, etc. The generated metadata for the features may be provided to other functions to assist with the preparation of the data. Similarly, the feature metadata may be use as inputs to the Analytics/ML function for learning about usage of the data preparation service. Note that the Metadata Generator may only focus on each feature, or the vector representation of the feature, individually.

After the input data are combined, the resulting dataset may be passed to the Data Format Checker operation to perform preliminary data clean operation. The Data Format Checker may utilize the metadata to check the validity of the data values for each feature to ensure the values are in the correct data type. For example, if the data type is numerical and the value appears to be a string, the checker may correct the error or pass the error information to other processing operations, e.g. append the error information to the metadata for the feature or provide the error information in the dataset context information. The Data Format Checker may be able to address certain format issues even if the data is correct. For example, the Data Format Checker may know from user output requirements that dates can be in the format mmddyyyy and detect that one or more data values contain the format mmdyyyy. The Data Format Checker may then make the necessary corrections to the data to meet the output requirements.

At this point, the data may be sent to the Initial Feature Engineering operation where desired features are identified and duplicate features are removed. User output requirements may provide information on what features are of interest to the ML application and the requirements may be utilized by the service to identify features to maintain or generate for data preparation. The output requirements may specify features with certain types or characteristics are unimportant and therefore may be removed. Alternatively, the output requirements may specify which features are of interest and features not matching the desired outputs may be removed. In addition, information from the Metadata Generator may be utilized to make the determination of what data may be removed. As an example for the data in Table 1, the Date2 and Date3 features may be removed as both are sub-sets of Date1. The service may be able to recognize that features Date1, Date2, and Date3 all are of the same data type even though the data representations may be different.

Once duplicate features are removed, the Data Input function may analyze the dataset to summarize the contents of the dataset for downstream functions. The Dataset Analyzer operation may incorporate feature metadata information it receives as part of the analysis and may update the metadata to show relationships between and/or among the different features. The Data Analyzer may consider the dataset in totality and may aim to uncover relationships among the different features. The output of the Data Input function may consist of the combined dataset, metadata information for each feature, and dataset context information about the entire dataset. The dataset context information may be organized as addendum to the individual feature metadata or as a separate informational element for the dataset. Note also that each data preparation function may perform analysis of the dataset during its operation (and which may not be shown in the example configurations that follows) and add to or remove information from the dataset context that is maintained by the service. The dataset context information may assist the operation of each function and may even be used to modify the function's configuration.

Based on the dataset context information, the data preparation service may suggest recommended processing operations for each of the subsequent functional blocks as shown in the architectural diagram of FIG. 1. The examples shown for each of the functional blocks of the data preparation service hereinafter may incorporate recommendations derived from the dataset context information. Using the data example of Table 1, the dataset context information may indicate Temperature1 and Temperature2 may be averaged together and likewise for Humidity1 and Humidity2. Other information may be provided, for example, to synthesize data for missing values by extrapolating from adjacent values. The dataset context information may also include the total number of dataset samples, the total number of features, a list of features required for cleaning and/or data transform, relationships between or among the features, suggested order of operations for cleaning and transforming the data, etc. The data preparation service may also interact with the user regarding the dataset to obtain verification to recommendations of the analysis, to validate the removal of feature(s), and to present the results of the analysis to the user. The user may also modify the dataset context information and provide new configurations to the service.

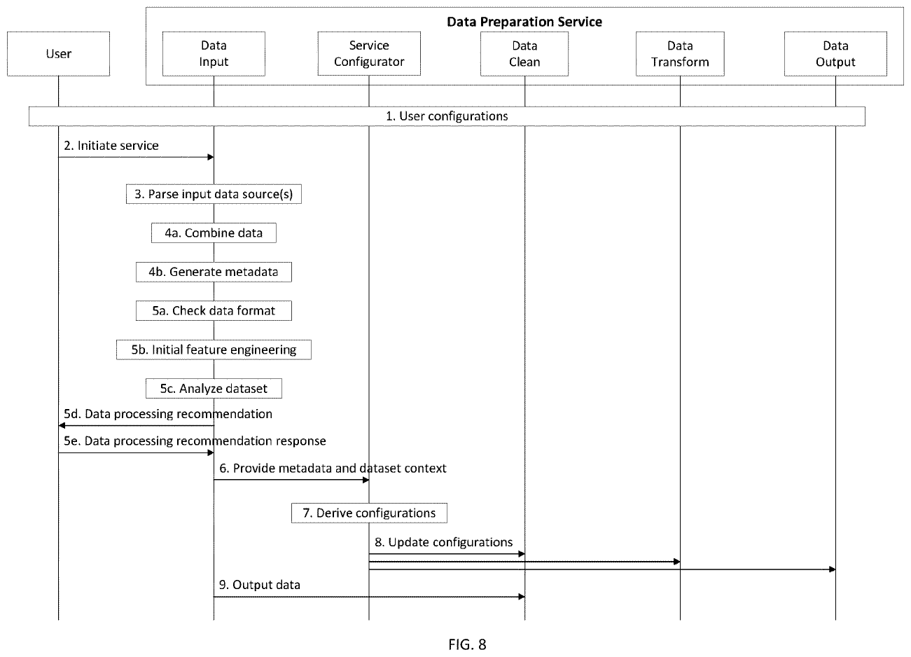

An example call flow of the interactions a user may have with the data preparation service to initiate service is shown in FIG. 8. The example call flow exemplifies how configurable the data preparation service is and how the combination of user output requirements, configurations (e.g. from user, service provider, and analytics/ML), and the dataset analysis performed by the Data Input function may be used to customize data preparation for the user.
Step 1: Same as Steps 1 to 5 of Service Configurator Call Flow procedure shown in FIG. 4.
Step 2: Same as Step 6 of Service Configurator Call Flow procedure shown in FIG. 4.
Step 3: The configuration of the Data Input function may follow the example as shown in FIG. 7. As a result, the Data Input function may first parse the input data sources. As part of this operation, feature metadata may be extracted by examining the data and using service provider, user, or analytics/ML configurations. The operation may also use available metadata from the input sources to identify the data for the features. Information about targeted machine learning application, the type and format of the data, and the units associated with the data values may also be extracted or combined with user output requirements and configuration.
Step 4: The output of the input parser may then be sent to both the Data Combiner and Metadata Generator operations. The Data Combiner may combine all the data from each of the input sources in a lossless manner, selectively combine the data from different input sources, or autonomously combine the input data sources if specified to do so by configurations. The result of the data combining may be a dataset that is in structured or tabular form to assist with further data preparation functions. Meanwhile, the Metadata Generator may create metadata for each of the features, which may incorporate information obtained from the Input Parser operation. Other context information may also be generated to show relationships between or among the different features.
Step 5: Once a dataset is available, some initial data processing may occur. First, the dataset may be checked if the format for a feature is in a consistent format and any incorrect data formats may be fixed. Second, initial feature engineering may be performed in which duplicate features may be removed. Third, the Data Input function may analyze the dataset to extract context information that may exist in the dataset. The Dataset Analyzer operation may utilize service provider configurations, user configurations, and/or analytics/ML configurations to uncover context information about the dataset. For example, knowledge of a particular ML application may identify that certain data clean or transform operations are required. In a finance ML application, data formats representing currency (e.g. in conjunction with location information) may be identified and certain transforms that more readily process currency, including currency conversion transforms, may be specified. The gathered context information may be combined with the feature metadata or the information may be stored separately from the dataset. Additionally and/or alternatively, the Data Input function may consult with the user to collect further input regarding information needed to perform the initial data processing. The Data Input function may leverage other functions (e.g., Service Configurator function or Report and Visualizer function) of the Data Preparation Service to consult with the user. When consulting with the user, a recommendation may be sent to the user. The recommendation may include one or more suggestions and/or options regarding data processing operations that the Data Input function may perform on behalf of the user. A response to the recommendation may also be received from the user. The response may include one or more data processing operations chosen and/or specified by the user. The Data Input function may also be equipped with an analytics/ML model that enables the Data Input function to infer which data processing operations may be performed on the dataset by the Data Input function. The analytics/ML model may rely on features of the dataset, context information extracted from the dataset, information from service provider configurations, user configurations, or analytics/ML configurations, and/or information the Data Input function receives in response to consulting with the user during the data input process.
Steps 6-9: The Data Input function may send the feature metadata and dataset context information to the Service Configurator, which may then update existing configurations of the remaining functions. Steps 7-10 of FIG. 4 may be performed for steps 6-9.

As previously mentioned, FIG. 8 shows an example of data preparation for unsupervised learning applications. The figure shows the absence of the Data Labeler function due to the requirement of the unsupervised ML application, which may have been provided as a user output requirement. In addition, the Data Synthesizer function was also omitted from the workflow due to the fact that the Dataset Analyzer operation of the Data Input function had detected no missing data as well as sufficient number of data instances in the dataset. This example highlights the capability of the Data Preparation Service to intelligently guide the user through the data preparation process and in a user friendly manner. The configurations of downstream data preparation functions may be determined or updated due to the analysis of the data and the resulting feature metadata and dataset context information extracted by the Data Input function.

### Data Clean Function

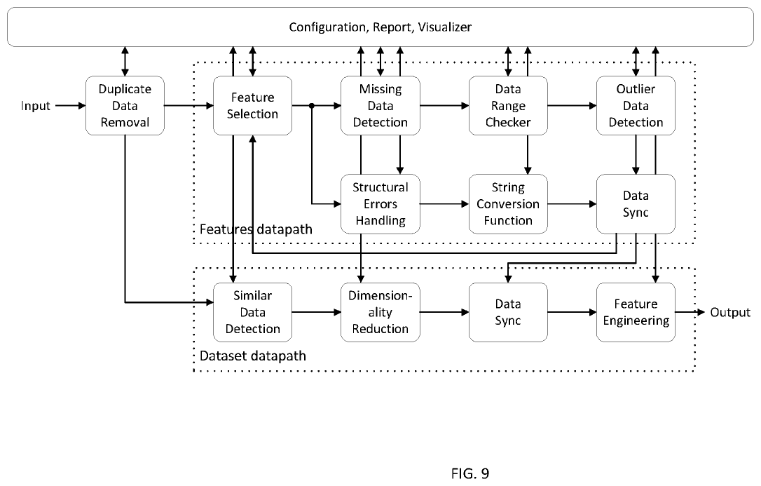

The Data Clean function may receive the combined dataset from the Data Input function with the associated feature metadata and dataset context information. The dataset context information may even be used to configure the necessary operations and/or order of operations to clean the dataset. FIG. 9 shows an example of a Data Clean configuration that may be configured with the dataset context information. The figure shows two paths for cleaning the dataset: one path that operates on each selected feature and a second path that operates on the entire dataset. Note that the example shown in FIG. 9 is just one example of a configuration for the Data Clean function; other configurations may be envisioned possibly with more than two datapaths depending on the cleaning requirements. Having multiple datapaths may shorten the data preparation process by introducing parallelism especially for larger datasets with many features.

One difference between the two datapaths shown in FIG. 9 is the scope with which the data is cleaned. In the feature datapath, data is cleaned for data belonging within the same feature and in the dataset datapath, data is cleaned with considerations to all features in totality. For each datapath, detection operations may be performed and the results are carried over to the next operation. The data are updated at a Data Sync operation and the Data Sync operation of each datapath may communicate with each other during each cleaning iteration to ensure the data are synchronized.

For the datapath that operates on features, a feature may be selected for data to be cleaned from a list of features. The list of features may be obtained from the dataset context information, from one of the configuration sources (e.g. user, service provider, or analytics/ML), or as a default (e.g. all the features of the dataset should be cleaned). Specific cleaning operations may then be performed on the data of the feature—each operation may detect what needs to be done and pass the information to the next operation. Additionally and/or alternatively, the Data Clean function may consult with the user to collect further input regarding information needed to perform the data cleaning operations. The Data Clean function may leverage other functions (e.g., Service Configurator function or Report and Visualizer function) of the Data Preparation Service to consult with the user. When consulting with the user, a recommendation may be sent to the user. The recommendation may include one or more suggestions and/or options regarding data cleaning operations that the Data Clean function may perform on behalf of the user. A response to the recommendation may also be received from the user. The response may include one or more data cleaning operations chosen and/or specified by the user. The Data Clean function may also be equipped with an analytics/ML model that enables the Data Clean function to infer which data cleaning operations are to be performed on the dataset by the Data Clean function. The analytics/ML model may rely on the features of the dataset, context information associated with the dataset, information from service provider configurations, user configurations, or analytics/ML configurations, and/or information the Data Clean function receives in response to consulting with the user during the data cleaning process.

Within the features datapath, operations that may be performed include detecting missing data, checking the range of data values based on metadata or configuration information, detecting data outliers, fix structural errors with the data values, perform string conversion functions, etc. Each operation may perform their respective functions or pass the information to the Data Sync operation for synchronization with the data from the dataset datapath. The features datapath shown in FIG. 9 further separates numerical processing from categorical processing, or data related to processing string based data. For categorical data, an operation may be to fix structural errors with the data values of a feature, such as misspellings and improperly formatted text. For example, certain categorical data may require abbreviations or certain string formats, such as membership identifiers, names, rankings, etc. In addition, certain algorithms or ML models may require numerical representations in place of strings for certain features. An example is with word embedding, where words are represented as a numerical vector. For these cases, a String Conversion function may perform such conversions.

In addition to cleaning data for features, the Data Clean function may also clean data from the perspective of the dataset. For large datasets, there may be instances in which two or more rows of data are duplicated. When this occurs, the data clean function may remove the duplicate data instances. In addition, the Data Clean function may be able to detect certain data instances share common values except for one or two features. In those instances, the data instances may even have conflicts in which the values of most of the features are the same and the values of one or two remaining features are in conflict with each other, e.g. have opposite values when the data type is Boolean. When these cases occur, it may signify the feature may not factor into the ML application and therefore, the feature may be removed. This is represented as the Dimensionality Reduction operation of FIG. 9. The user may be consulted by the service for these cases to ensure feature removal is known and acknowledged.

The example in FIG. 9 shows some of the cleaning operations operating in sequence while other operations are performed in parallel. It is noted that the data clean function may be configured that all cleaning operations are performed in parallel and the output of the corresponding detection operations are sent to a Data Sync operation to perform the actual operations to ensure that any operation involving the modification or removal of data are synchronized.

The Data Clean function may also receive configurations from the data preparation service to determine the processing requirements. For example, user configurations may specify that dataset samples with missing values are removed or dataset samples that have values outside a certain range for a particular feature are also removed. The user may specify such configurations to minimize processing in downstream functions to improve efficiency or to reduce data preparation time.

### Data Synthesizer Function

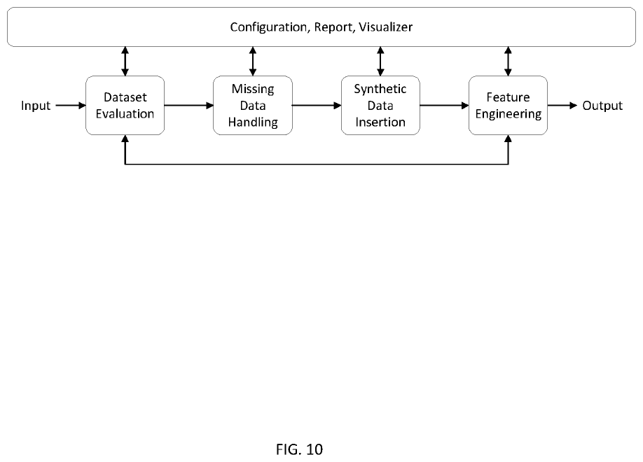

The Data Synthesizer function may only be required if there are missing data in the dataset or if dataset context information and/or configurations indicate that synthetic data may be needed. The dataset may be received from the Data Clean function and an evaluation may first be performed on the dataset. The evaluation may use the missing data information from the Missing Data Detection operation of the Data Clean function, any dataset context information that relates to the missing data, and/or user configurations, service provider configurations, or analytics/ML configurations. The result of the dataset evaluation may be used to identify whether synthesized data are required and specify how data are to be synthesized. An example of a configuration for the Data Synthesizer function is shown in FIG. 10.

The Data Synthesizer function may also consult with the user to collect further input regarding information needed to perform the data synthesis. The Data Synthesizer function may leverage other functions (e.g., Service Configurator function or Report and Visualizer function) of the Data Preparation Service to consult with the user. When consulting with the user, a recommendation may be sent to the user. The recommendation may include one or more suggestions and/or options regarding data synthesis operations that the Data Synthesizer function may perform on behalf of the user. A response to the recommendation may also be received from the user. The response may include one or more selected data synthesis operations and/or options specified by the user. The Data Synthesizer function may also be equipped with an analytics/ML model that enables the Data Synthesizer function to infer which data synthesis operations are to be performed on the dataset and how data is to be synthesized by the Data Synthesizer function. The analytics/ML model may rely on the features of the dataset, context information associated with the dataset, information from service provider configurations, user configurations, or analytics/ML configurations, and/or information the Data Synthesizer function receives in response to consulting with the user during the data synthesis process.

After the dataset have been evaluated, the dataset may be passed to the Missing Data Insertion operation with any information required for the operation to add missing data. Missing data may be generated and added to the dataset based on surrounding data values for a feature, which may be provided by the information derived during the evaluation or received as inputs to the function, e.g. through user configurations, service provider configurations, and/or analytics/ML configurations. For example, surrounding data may be used in a moving average calculation to identify a value to insert into the missing value. The value may further be constrained with upper and lower bounds that are based on adjacent values. For more complex requirements, the added value may be obtained from putting the available data into a time-series function and using the output of the time-series function as the data to be inserted. Note that the operations may operate on a feature basis but the evaluation may also be performed on the entire dataset to ensure certain contexts of the dataset are considered and accounted for, especially based on relationships between and among the features.

In some cases and especially if the dataset size is small, synthetic data may be generated to supplement the dataset. Analytics/ML or user configuration and/or user interaction may be required to assist with the synthetic data generation. For Analytics/ML configuration, the dataset may be sent to Analytics/ML models or algorithms in the Analytics/ML function to identify data combinations that are missing in the dataset as shown in the example of FIG. 6. The Analytics/ML function may analyze the variety of values for each feature to determine gaps in values that may be used for generating synthetic data. In addition, the Analytics/ML function may also examine the entire dataset to determine missing combinations of values from a dataset sample perspective. Analytics/ML models or algorithms may then combine the results of the aforementioned operations to generate synthetic dataset samples that may be added to the dataset. The Analytics/ML function may then forward the generated synthetic data to the Synthetic Data Insertion operation. Alternatively, the Analytics/ML function may forward the results of its analysis to the Synthetic Data Insertion operation to generate the synthetic dataset samples. In either case, additional information are added to the context information associated with the dataset to identify the synthetic data. Statistic information such as number of synthetic samples and percentage of dataset consisting of synthetic data may be included for reporting purposes.

Synthetic data may also be generated from user configurations. A user may specify output requirements for dataset size and may also include synthetic data generation rules to use when the dataset size is not met. The generation rules may be incorporated with the analysis of the Analytics/ML function to synthesize the data. The user configuration may also specify the maximum number of synthetic samples that may be added to the dataset or the percentage of the dataset that may consist of synthetic data.

The output of the Synthetic Data Insertion may then be sent to the Feature Engineering operation to perform an analysis of the dataset once all the data are available. The analysis may uncover the ability for the service to generate new features based on existing data that may provide more insights into the ML application. For example, a ratio may be generated based on existing features as part of feature engineering to represent data in another format. An example may be to create a new feature on property price per square feet using the property sale price and the square footage of the property features. This new feature may allow for comparison between and among houses in different price ranges that offers an additional insight for a real estate ML application.

The addition of synthetic data may also change the characteristics of the dataset or the relationships of the values between or among the features. As a result, the Feature Engineering operation may also analyze the dataset to check whether any added synthetic samples may have introduce a conflict with an existing dataset sample. For example, Table 2 shows a value that was inserted for feature C of sample 1197 that introduced a conflict between samples 1194 and 1197, mainly the value for feature C differs but the values for features A, B, and D are the same. A value of 0 may have been inserted by the Missing Data Handling operation due to an imbalance of 1's and 0's discovered for feature C. Therefore, the Feature Engineering operation provides an additional check to ensure any added synthetic data does not negatively impact the rest of the dataset. Note that the Reporting and Visualizer function may also highlight the discrepancy between samples 1194 and 1197 as well to inform the user. Similarly, the processing report sent to the Analytics/ML function may also highlight the discrepancy. The Feature Engineering operation offers an automated method to detect the discrepancy and may even remediate it, e.g. by removing sample 1197. As previously stated, various operations such as the Feature Engineering operation described here may be utilized in different data preparation functions since data preparation is such an iterative process and having multiple instances of the operation in different functions may help reduce the number of iterations performed between functions.

TABLE 2
Example of Conflict with Synthesize Data

Features

| Sample # | A | B | C | D |
|---|---|---|---|---|
| 1190 | 65 | 7 | 1 | N |
| 1191 | 32 | 10 | 1 | Y |
| 1192 | 59 | 4 | 0 | Y |
| 1193 | 88 | 8 | 1 | N |
| 1194 | 23 | 2 | 1 | Y |
| 1195 | 76 | 3 | 1 | Y |
| 1196 | 11 | 9 | 1 | N |
| 1197 | 23 | 2 | 0 | Y |

### Data Transform Function

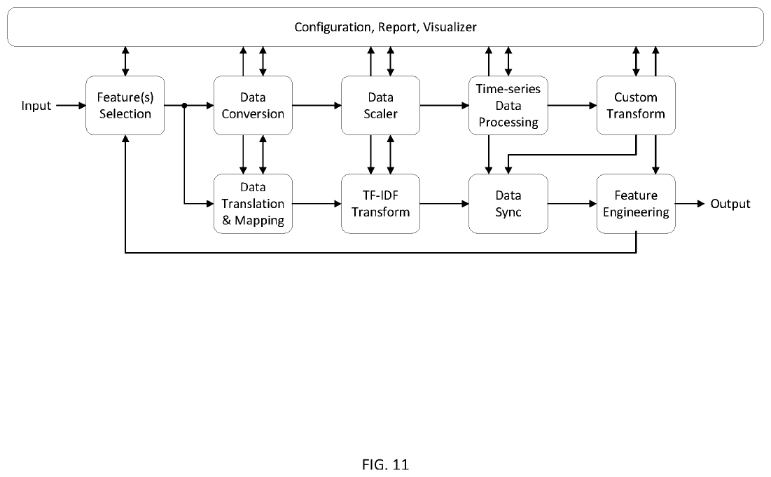

Thus far, data have been extracted from input sources, cleaned, and possibly synthesized as part of data preparation. The dataset may then be ready to be transformed into whatever format that may be required as indicated by output requirements from the user. The process of transforming data may be realized by the example configuration shown in FIG. 11. As previously mentioned, the dataset context information generated by the Data Input function may be utilized to configure transformation operations as shown by the example. In addition, the dataset context information may also be updated by other data preparation functions based on the results of analysis the function may perform. The Data Transform function may consult with the user to collect further input regarding information needed to perform the data transformation. The Data Transform function may leverage other functions (e.g., Service Configurator function or Report and Visualizer function) of the Data Preparation Service to consult with the user. When consulting with the user, a recommendation may be sent to the user. The recommendation may include one or more suggestions and/or options regarding data transformation operations that the Data Transform function may perform on behalf of the user. A response to the recommendation may also be received from the user. The response may include one or more selected data transformation operations and/or options specified by the user. The Data Transform function may also be equipped with an analytics/ML model that enables the Data Transform function to infer which data transformation operations are to be performed on the dataset and how data is to be transformed by the Data Transform function. The analytics/ML model may rely on the features of the dataset, context information associated with the dataset, information from service provider configurations, user configurations, or analytics/ML configurations, and/or information the Data Transformation function receives in response to consulting with the user during the data transformation process.

The Data Transform function may process the dataset at different levels, from an individual feature, to a group of features, or even the entire dataset. A Feature(s) Selection operation determines the level of granularity that the data transform is performed on. The Feature(s) Selection operation may be controlled by one of the configurations (e.g. user, service provider, analytics/ML) provided by the service, by the dataset context information, or even interactively by the user.

After one or more features are selected, the data transformation process may commence. FIG. 11 shows an example configuration where the data transformation has two paths, one path for numerical transformations and another path for categorical transformations. Additional paths may be envisioned where data requiring special transforms are processed such as for images, videos, audio, and other data types. For iterations where only numerical or categorical data are present, processing may only be performed for one path. Therefore, instructions may be provided by configurations, feature metadata, dataset context information, or even from the user on what data transform operations are required for a particular data transform iteration.

For numerical data, the Data Conversion operation may be used to convert data from one unit to data in another unit. In addition, data may also be converted from one form into another form, such as calculating the age of a person based on their birthdate.

The Data Scaler operation may perform various statistical or mathematical operations on the data as some ML models may require data to be within a certain range. An analysis may be performed to determine the data range, which may be used to assist with the scaling. Examples of scaling operations may include min-max scaling, standard deviation, logarithmic, power transformer, unit vector scaling, etc. For certain cases, if the data contains outliers or values different from the majority, then saturation logic may be employed to ensure values are within the desired range. In these cases, maximum and minimum values may be specified either by configurations or interactively by the user and applied as the saturation value.

In certain instances, the dataset may contain time-series data that may require processing to fit within the output requirements. Within the time-series data, there may be missing values, improperly aligned data, samples taken at different time intervals, etc. The Time-series Data Processing operation may attempt to fill in the missing data, correct invalid data, resampling data for alignment, and create features to group data together. Different types of transforms may also be applied to the time-series data, for example, a power transform, a difference transform, a standardization transform, or a normalization transform. The different types of transforms may even be applied sequentially to obtain the desired result.

Another consideration for numerical processing is the ability for a user to specify domain specific or custom data transformation operations. The user may require special transformations that the data preparation service may not offer and provide the transformations as user output requirements. The specification may be custom code provided by the user or an API or URL to some custom built function. As shown in the example, the output of the custom transformation may be sent to the Data Sync operation to be synchronized with data from another path.

The data preparation service may also support transforming categorical data by providing the Data Translation and Mapping operation. Typically, ML algorithms or models operate better with numerical data, especially for ML applications involving regression. Data translation and mapping may be required when the data preparation service is not able to recognize the data context. This may especially apply to string data types or alphanumeric data. If user output requirements or feature metadata indicates a feature contains a certain number of categories, the operation may be able to translate each of the category to a numerical value. The operation may then add the mapping of the values to the corresponding category to the feature metadata for use with interpreting the inference results if necessary. During this process, a new feature may be created with the enumerations saved as metadata for interpretation of the values.

Another potential application of the Data Translation and Mapping operation may involve the processing of text inputs, especially for Natural Language Processing (NLP) applications. For this type of application, text inputs may need to be translated into a more readily accessible format for an ML algorithm or model. Text vectorization is a popular approach to perform such translation. Text vectorization defines a numerical vector to represent all the words encountered for a particular ML application. When a word is encountered, the corresponding position in the vector is indicated with a “1”; if the word is not present, then the position is indicated with a “0”. Text vectorization may be enhanced to better recognize similarities between words and designed to allow for vector arithmetic to find similarities between words.

The TF-IDF Transform operation may be another method to process textual inputs. TF-IDF is short for Term Frequency—Inverse Document Frequency and is an algorithm that aims to weight terms used in a document to provide contextual information to the use of the term. The algorithm consists of two component, a Term Frequency component and an Inverse Document Frequency component. The first component determines the frequency that a term appears in a document and the second component determines the frequency of the appearance of the term in all the documents of the dataset. A TF-IDF value may be obtained by multiplying the values to provide a measure of importance of a term in the text. This value may be added as a feature to the dataset.

A Data Sync operation may be performed once data from the respective paths are available. The Data Sync operation may check that the datasets from the different paths are still aligned and to include any new features. If the same feature was processed in separate paths, the operation may check for discrepancies in values between the two paths and notify the discrepancy in a report to the user.

After the data have been synchronized, the Feature Engineering operation may examine any new features that may have been added and determine if feature reduction may be applied to the dataset. It may be that the added feature(s) may replace existing feature(s) of the dataset. As an example, the new feature “Age” may be calculated from the birthdate feature and for a particular ML application, the birthdate feature may not offer any benefit towards the inferencing and may be removed. The user output requirements or user interactions with the service may also assist with determining which features are important for the desired ML application.

The process may then repeat for other features in the dataset until all the features have pass through the Data Transform function. The output may include the dataset and any updates to the feature metadata as well as modifications to the dataset context information that the function may have made.

### Data Labeler Function

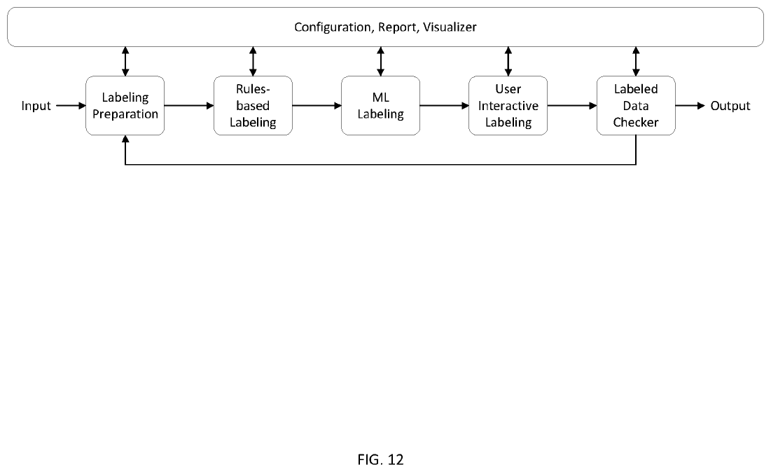

When labeled data are required, the Data Labeler function may be enabled to provide assistance for data labeling. An example configuration of data labeling operations is shown in FIG. 12. Using the example figure, data labels may be created using rules-based labeling operation, machine learning labeling operation, and/or user interactive labeling operation. This function may be the most dependent function where domain expertise may be required. The service may be able to learn, however, from past data preparation workflows to provide some level of labeling support through the Analytics/ML function and the ML Labeling operation.

One simple mechanism for labeling data is for the user to provide data labeling rules in the form of user output requirements. The data labeling rules may be provided to a rules-based labeling engine that evaluates the rules against the indicated data and make a determination of what labels should be applied to the data instance. The rules may be simple and identify conditions for one or more features to be evaluated or the rules may be quite complex where multiple groups of features are evaluated. When the criteria for the data labeling rules are met by the data, then the corresponding label may be applied to the data. Note that the label may be a value, the output of some function that may be based on the values of the data, or a prompt to the user for the label. As a result of this process, a new feature may be created to identify the labels.

Another data labeling mechanism may be to use analytics or machine learning capabilities of the data preparation service to assist with the labeling. The service may offer analytics/ML functionality to group data into clusters and prompt the user to label data a data sample in each identified cluster. The number of clusters may be obtained from user output requirements or even from the analytics/ML functionality based on the data inputs. The analytics/ML Labeling operation may then autonomously label the remaining data in each cluster with the same label as provided by the user for that cluster. The analytics/ML Labeling operation may highlight data instances where the confidence level is lower than a configured threshold in the data preparation report to notify the user that additional review may be required.

For some labeling applications, the data preparation service may not be able to properly label the dataset and may require user interactions to complete the labeling. In these instances, the service may provide recommended labels, e.g. from the Analytics/ML function based on past observances of data labeling operations for the same application type, and let the user accept or override the label. The User Interactive Labeling operation may interact with the Preparation Report and Visualizer function to enable such labeling. Data may be provided to the visualizer function to display graphically or to present in tabular form to show the relationship of the features with one another. The service may then use the user labels to adjust the recommendations of subsequent data instances to further streamline the labeling process.

Each of the aforementioned labeling operations may generate a new feature to be added to the dataset or be used in combination as a single feature. One benefit of keeping the labels from the different labeling operations separate may be to compare the labeling operations to see which mechanism may offer the best results. The information may even to be sent to the Analytics/ML function to analyze and learn about the data labeling process for a particular ML application type. The learnt behavior may then be utilized to offer assistance to future labeling operations. When the labeling operations are used collectively to label a single target feature, each mechanism may be used to supplement each other to complete the labeling function.

Prior to outputting the labeled data, a final labeling check may be performed to ensure the integrity of the dataset is maintained. If the labeling operations had generated separate features for each of the labeling operations, the Labeled Data Checker may select one of the features to use in the final dataset based on various criteria, such as user output requirements, labeled data distribution, or user selection. The checker may combine the labels from each feature into a single targeted feature, attempt to resolve any conflicts that may arise, and notify the user of any unresolved conflicts. A check may also be performed to detect conflicting data instances in which values for all the features of a data instance are the same except for one or two features. This may have undesirable impacts to the ML algorithm or models. The checker may determine to remove one of the data instance and provide information to the preparation report to alert the user. In addition, the checker may also check for data instances with similar values and if the dataset is sufficiently large, to remove one or more data instances. Additionally and/or alternatively, the Labeled Data Checker may notify the user in the preparation report or interactively. Other information that may be reported are the distribution of the labels, the frequency of each label categories, the level of confidence of the labeled data, the percentage of labeled data with high confidence, etc.

Once all data have been labeled, the Data Labeler may send the updated dataset with the labels and associated feature metadata and dataset context information to the next configured function.

### Data Output Function

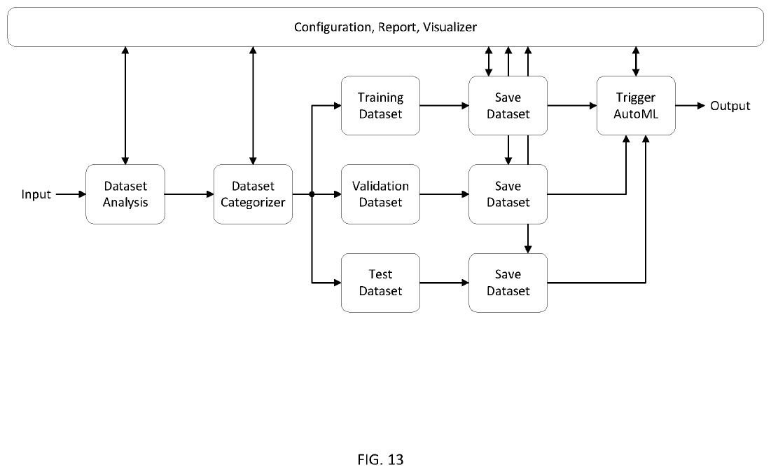

An example configuration of the Data Output function is shown in FIG. 13. The Data Output function may be the last function of the data preparation service and may perform a final analysis of the dataset in a holistic manner given prior analysis was performed but within the constraints of the independent functions. The Dataset Analysis operation in the Data Output function may focus on the overall dataset and may obtain pertinent statistics about the dataset such as total number of data instances, the number of features, the variance of the data of the features, the distribution of the data, etc. The analysis may also check for duplicate or similar data instances that may be removed and prepare the dataset for training. If the dataset analysis encounters too many issues, data processing may be routed to a prior function to address the appropriate issues.

After the dataset analysis, a Dataset Categorizer may be utilized to separate the dataset into training dataset, validation dataset, and test dataset. A user output requirement may specify the percentage distribution for each of the dataset categories. In addition to the categories of the dataset, the Dataset Categorizer may consider the data distribution of the labels and certain critical features when dividing the data instances into the different categories. The Data Categorizer may use the information obtained from the Data Analyzer or user output requirements to divide the dataset. The Data Categorizer may also consult with the user to collect further input regarding information needed to perform the data categorization. The Data Categorizer may leverage other functions (e.g., Service Configurator function or Report and Visualizer function) of the Data Preparation Service to consult with the user. When consulting with the user, a recommendation may be sent to the user. The recommendation may include one or more suggestions and/or options regarding data categorization that the Data Categorizer may perform on behalf of the user. A response to the recommendation may also be received from the user. The response may include information on how to separate the dataset into the different categories as specified by the user. The Data Categorizer may also be equipped with an analytics/ML model that enables the Data Categorizer to infer how to split the dataset, e.g. based on distribution of features and/or labels. The analytics/ML model may rely on the features of the dataset, context information associated with the dataset, information from service provider configurations, user configurations, or analytics/ML configurations, and/or information the Data Categorizer receives in response to consulting with the user during the data categorization process.

Once the dataset have been divided, the resulting datasets may be saved to a specified repository either internally within the data preparation service or externally via a URI. The datasets may even be sent as part of a command to trigger an AutoML process for training an ML model with the prepared data. Alternatively, the locations of the saved datasets may be sent to the next step in the machine learning pipeline for use in training a model. All associated feature metadata and dataset context information may also be included.

### Data Preparation Report and Visualizer Function

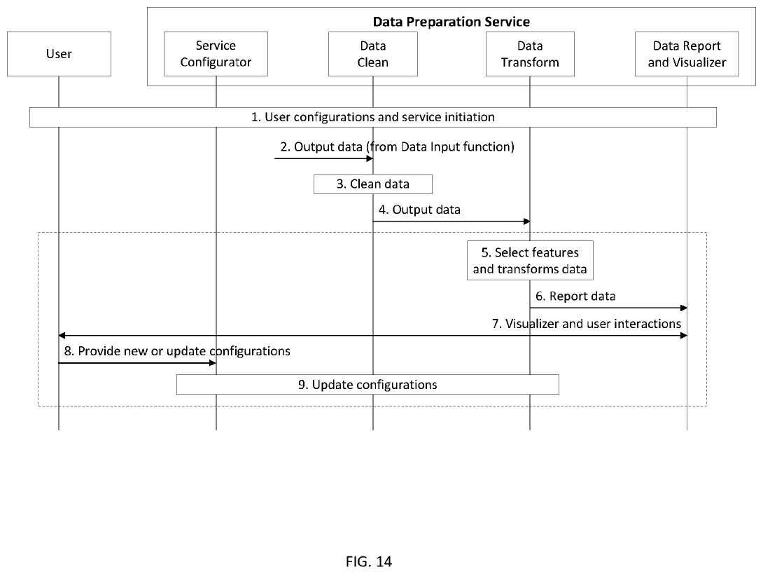

Another feature of the Data Preparation Service that provides a user friendly mechanism during the data preparation process may be the Data Preparation Report and Visualizer function. This functional block may provide users with direct access to the data preparation process and complete visibility to each operation of the process. Preparation reports may be generated after each operation and saved for future reference, e.g. to assist with debugging issues that may be hidden during the data preparation workflow. Some interactions may be required with the user during the preparation process and a visualizer function may be presented to show information to the user or to request information from the user. For example, the visualizer function may show before and after artifacts of the data to inform the user of what was done. The visualizer function may also be presented to the user when user interactive labeling is required from the user. FIG. 14 shows an example call flow highlighting the interactions between the Data Transform function with the Data Preparation Report and Visualizer function. Note that while FIG. 14 does not show interactions between the Data Clean and Data Preparation Report and Visualizer functions, the functions may also have interactions with each other, similar to the interactions that are shown in the figure between the Data Transform and the Data Preparation Report and Visualizer functions. Other functions of the data preparation service may also have similar interactions with the Data Preparation Report and Visualizer function.
Step 1: A user may provide the Data Preparation Service with user output requirements and configurations and may have also initiated the data preparation service. As part of initiating the service, the user may have identified one or more data input sources. The user output requirements and configurations may inform the data preparation service on what functions and operations the user may need. As a result, the service may generate a workflow as shown in the figure to link the Data Transform and Data Preparation Report and Visualizer functions together as there may be a custom transform that is specified by a user configuration that may require interactions with the user.
Step 2: The user has specified one or more input data sources and the Data Input function may have generated the appropriate dataset with the associated metadata and dataset context information. Note this is not shown in the figure. The outputs of the Data Input function, which may include the dataset, the feature metadata, and dataset context information, are sent to the Data Clean function in this step.
Step 3: The dataset is cleaned by one or more cleaning operations in the Data Clean function. Information may be sent from the Data Clean function to the Data Preparation Report and Visualizer function to provide access for the user to observe how the data was cleaned. Note this interaction is not shown in the figure. Reports may also be generated as well. The level of reporting and access may be specified by user configurations prior to service initiation or it may be performed dynamically as the data is being processed.
Step 4: After the data have been cleaned, the dataset output and associated information (e.g. feature metadata and dataset context information) may be sent to the Data Transform function.
Step 5: The Data Transform function may transform the data for specified features that may have been identified by user output requirements and/or configuration, by dataset context information, and by the Analytics/ML function based on learnt behaviors about certain ML applications.
Step 6: When a feature that requires the custom transform is selected, the Data Transform function may send data reports and other information to the Data Preparation Report and Visualizer function to interact with the user.
Step 7: The Data Preparation Report and Visualizer function may present the reports and information obtained from the Data Transform function to the user through a GUI on a client or web application. The Data Preparation Report and Visualizer function may also query the user to provide information to assist with the custom data transform, e.g. a domain specific transform that the data preparation service may not have, and the user may provide a response via the GUI to specify the custom transform. Similar interactions may also occur with other steps in the workflow to query the user for input. If a URI for the custom transform was provided, the Data Preparation Report and Visualizer function may access the custom transform using the provided URI. In that case, communication with the user may not be necessary.
Step 8: The user may provide new or updated configurations to the Service Configurator to indicate changes that the user may want the service to implement. The user may be responding to a prompt by the service in step 7 to provide information for a domain specific transform or to undo a transform that the user had noticed was not the best transform to use.
Step 9: If required, the Service Configurator may update the configuration of the functional blocks that may be affected by the new or updated user configurations. In this example, the updated configurations may be sent to both the Data Clean and Data Transform functions as the user may request the data flow may need to be cleaned after transforming the data. Note that steps 5 to 9 may be repeated during the data transform stage for many iterations and the user may only be prompted to address any issue the service is not able to resolve.

Note that FIG. 14 shows only an example of the interactions between one of the individual functions within the data preparation service with the Data Preparation Report and Visualizer function and between the Data Preparation Report and Visualizer function and the user. As previously stated, the Data Preparation Report and Visualizer function may interact with any of the functions presented in FIG. 1 for a particular ML application workflow.

The Data Preparation Report and Visualizer function may receive processing reports from each of the functions to document the data preparation process for the user. As a result, the user may be able to review any artifact generated by the data preparation service in case there is an issue with the dataset. The user may access the report and visualizer function at any time and obtain various representation of the dataset. For example, the user may want to find the relationship of a group of features and obtain a graphically representation of the features with one another, e.g. a 3-dimensional graph of the features. The user may also view the data label distributions of a multi-category feature to see if there are equal distribution for each of the label. Note that the processing reports received from the data preparation functions may be the same as or different from the processing reports sent to the analytics/ML function. The reports may have different levels of information with the reports sent to the analytics/ML function having a subset of information for easier processing to find patterns in the dataset as opposed to the reports send to the report and visualizer function, which may require detailed information to document the data preparation process. The user may then be able to filter among the different levels of reporting to simplify or target the review of the reports.

### API

Previously, the focus of user interactions with the data preparation service was mostly GUI based. However, the proposed functionality for the data preparation service may also be realized through API calls made by the user to the data preparation service. Note that the user may interact with the service via both the API and GUI and for instances where a graphical representation may be beneficial, the user may interface with the service via a GUI. Below are examples of API calls that the data preparation service may expose to users. These APIs may be realized as RESTful APIs comprising one or more resources. The resources may comprise one or more attributes or child resources comprising the parameters defined for each API. The resources may be addressed via Uniform Resource Identifier (URI).

### Service Initiation API

A user may use the InitiateService API to initiate the data preparation service for a specific ML application. Examples of parameters for the API may be those as shown in Table 3.

TABLE 3
Example Data Preparation Service Initiation API

| API Name | InitiateService |
|---|---|
| API Description | Initiates the data preparation service |
| Parameters | Description |
| MLApplicationType | The type of ML application requested for the |
| | application such as finance, environmental, |
| | industrial, sports, etc. Sub-types may also be |
| | specified to identify a specific industry or ML |
| | application, such as banking, insurance, stock |
| | market, meteorology, real estate, farming, |
| | automotive, baseball, etc. |
| DataInputSources | Specifies the number of input data sources; data |
| | location may be from URIs or inline within the API |
| DataInputURIs | The URI(s) of the data sources |
| DataInputs | The data inline within the payload of the API |
| OutputRequirements | See Table 4 |
| UserConfigurations | See Table 4 |

The response to the InitiateService API may contain the following: transaction identifier, status of the request, ML application identifier, failure code and reasons for failure if unsuccessful, and a timestamp. The user may use the ML application identifier to interact with the data preparation service for changes to the data preparation tasks and to retrieve data preparation reports after receiving a successful response.

### User Configuration API

A user may use the CreateUserConfiguration API to specify output requirements and user configurations for a specific ML application. Examples of parameters for the API may be those as shown in Table 4.

TABLE 4
Example User Configuration API

| API Name | CreateUserConfiguration |
|---|---|
| API Description | A user may create output requirements and user configurations for a specified ML application |
| Parameters | Description |
| MLApplicationID | Specifies the ML application identifier the API refers to |
| MLApplicationType | The type of ML application requested for the application such as finance, environmental, industrial, sports, etc. Sub-types may |
| | also be specified to identify a specific industry or ML application, such as banking, insurance, stock market, meteorology, real |
| | estate, farming, automotive, baseball, etc. |
| OutputRequirements | |
| MLtype | Specifies the type of machine learning, such as supervised, semi-supervised, unsupervised, reinforcement learning, etc. |
| MaximumInputs | Specifies the maximum number of input features |
| RequiredInputs | Specifies the required features in the final dataset |
| MaximumFeatures | Specifies the maximum number of total features |
| MinDataSamples | Specifies the minimum number of data samples required |
| TargetFeature | Specifies the target feature for the ML application |
| TargetModel | Specifies the target algorithm or model for the ML application |
| OutputPercentage | Specifies the percentage of the dataset samples for train, validate, and test |
| ReportLevel | Specifies the level of reporting collected by the Data Preparation Report and Visualizer function, e.g. from 1 to 5 |
| AutonomousMode | Specifies the allowance for the service to automate the data preparation workflow which enables the service to offer |
| | recommendations for data processing tasks |
| UserConfiguration | |
| Name | Specifies the name of the user configuration |
| ApplicationType | Specifies the ML application type the user configuration applies to |
| Functions | Specifies the data preparation functions the user configuration applies to |
| Conditions | Specifies the conditions for which the user configuration is triggered |
| Process | Specifies the processing that is performed once the user configuration is triggered |

OutputRequirements may be specified to provide ML parameters for controlling the operations of the service, such as the maximum number of features and the minimum number of samples for a dataset. UserConfigurations may be specified to impact certain functionality specific to the data preparation workflow. For example, a user configuration may be specified as follows (and note the example is not meant to limit what a user configuration may be): Name: OneHotEncode; ApplicationType: Finance-RealEstate; Functions: DataTransform; Conditions: if (feature==“State”∥feature==“State Abbrev”); and/or Process: Operation=“One Hot Encode”.

The response to the CreateUserConfiguration API may contain the following: transaction identifier, status of the request, output requirement identifier, user configuration identifier, failure code and reasons for failure if unsuccessful, and a timestamp. In addition to the Create* API, Retrieve*, Update*, and Delete* APIs may also be made available to allow the user to retrieve, modify, and remove respectively the indicated output requirement and/or user configuration using the associated identifier(s) returned in the CreateUserConfiguration API response.

### Retrieve Data Preparation Report API

A user may use the RetrievePreparationReport API to retrieve data preparation reports for a specific ML application. Examples of parameters for the API may be those as shown in Table 5.

TABLE 5
Example Retrieve Data Preparation Report API

| API Name | RetrievePreparationReport |
|---|---|
| API Description | A user may retrieve data preparation reports from the service |
| Parameters | Description |
| MLApplicationID | Specifies the ML application identifier the API refers to |
| Function [ ] | Specifies the data preparation function the report is requested from; there may be multiple instances of the Function |
| | parameter to retrieve reports from multiple functions |
| Operation [ ] | Specifies the operations the report; there may be multiple instances of the Operation parameter to retrieve reports |
| | from multiple operations |
| ReportLevel | Specifies the level of reporting collected to be returned, e.g. from 1 to 5 |

The response to the RetrievePreparationReport API may contain the following: transaction identifier, status of the request, report information, failure code and reasons for failure if unsuccessful, and a timestamp. The report information may be in JSON format and be included inline in the response or provided as a list of URIs where the reports may be retrieved from.

### Service Recommendation Subscription API

The data preparation service may receive a subscription request from a user or ML application. Examples of parameters for the subscription may be those as shown in Table 6.

TABLE 6
Example Service Recommendation Subscriptions

| API Name | CreateSubscription |
|---|---|
| API Description | The data preparation service may receive a |
| | subscription to receive notifications for data |
| | preparation recommendations |
| Parameters | Description |
| MLApplicationID | Specifies the ML application identifier the |
| | API refers to |
| RecommendationType | The type of requested recommendation |
| | notifications of interest |
| NotificationURI | The URI of where the notification is to be sent to |
| Function [ ] | The function(s) for which the subscription is for |
| Operation [ ] | The operation(s) for which the subscription is for |

In response to receiving the subscription request, the service may return a transaction identifier, the status of the request and a SubscriptionID if the request was granted, failure code and reasons for failure if unsuccessful, and a timestamp. The user may use the SubscriptionID to perform retrieves, updates, or deletions of the subscription. Additionally and/or alternatively, the subscription may be implicitly created by the service through the AutonomousMode parameter specified in Table 4.

### Service Recommendation Notification API

The data preparation service may send a notification with recommendations of data preparation tasks to the user. Examples of parameters for the notifications may be those as shown in Table 7.

TABLE 7
Example Service Recommendation Notifications

| API Name | ServiceNotification |
|---|---|
| API Description | The data preparation service may send the user a notification with recommendations for data preparation tasks |
| Parameters | Description |
| MLApplicationID | Specifies the ML application identifier the API refers to |
| SubscriptionID | Specifies the identifier of the subscription the notification is for; for implicit subscriptions, this parameter may be an internally |
| | generated identifier of the service |
| RecommendationType | The type of recommendation: configuration or function |
| RecommendationURI | The URI of the recommendation a user can access via a GUI |
| Function | The function for which the recommendation is made for |
| Operation | The operation for which the recommendation is made for |
| Recommendations | The details of the recommendation, including the current state prior to the recommendation |

In response to the notification, a user may return a response indicating the acceptance or rejection of the recommendation. Alternatively, the user may access the RecommendationURI parameter to display the details of the recommendation on a GUI and provide the response via the GUI.

### Example Communications System

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHZ, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

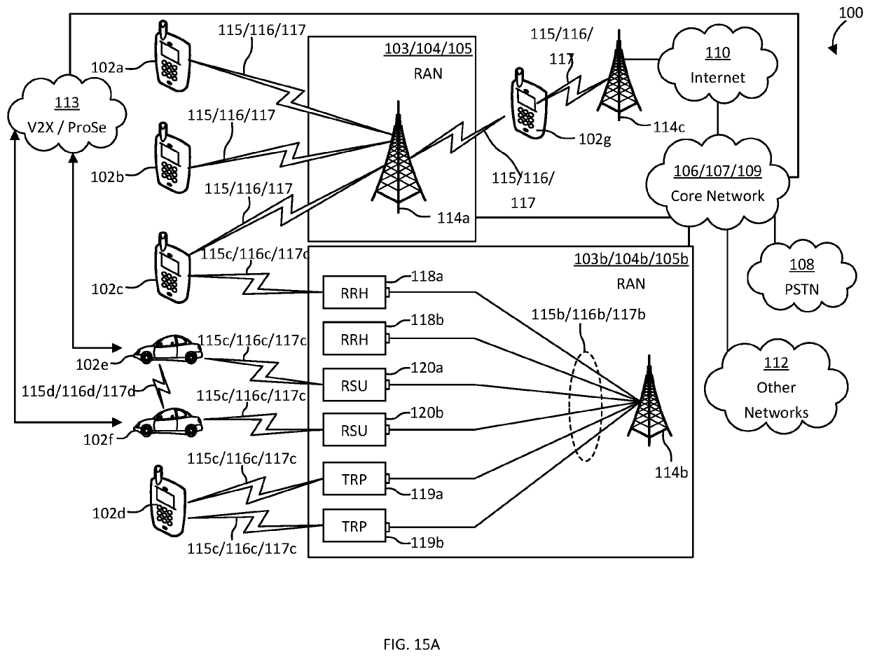

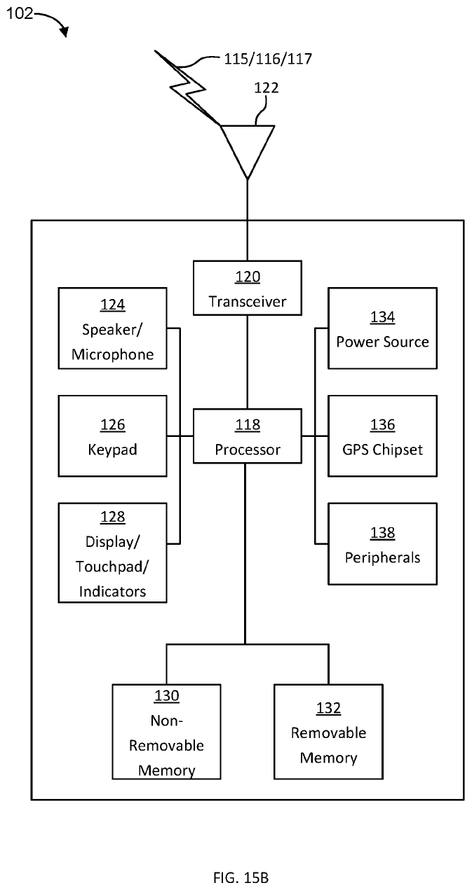

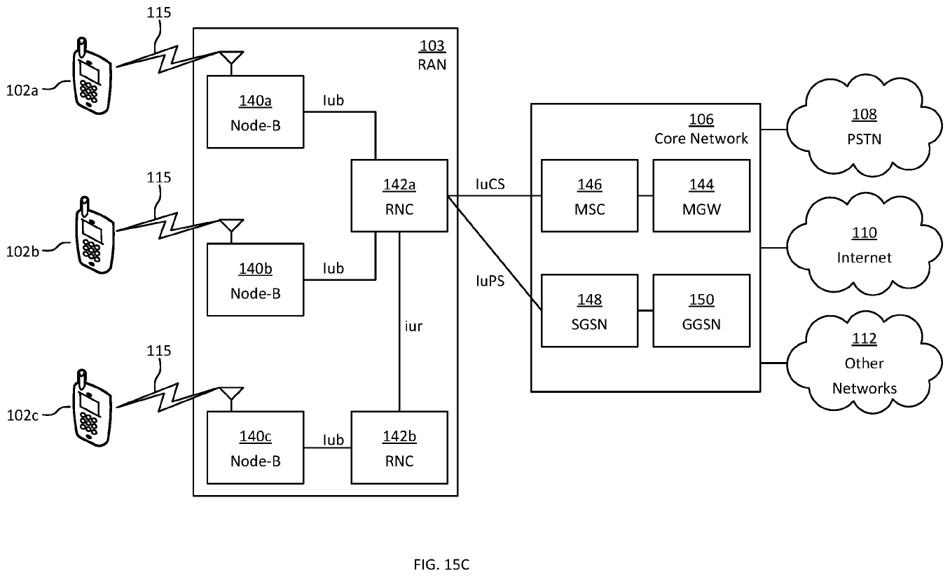

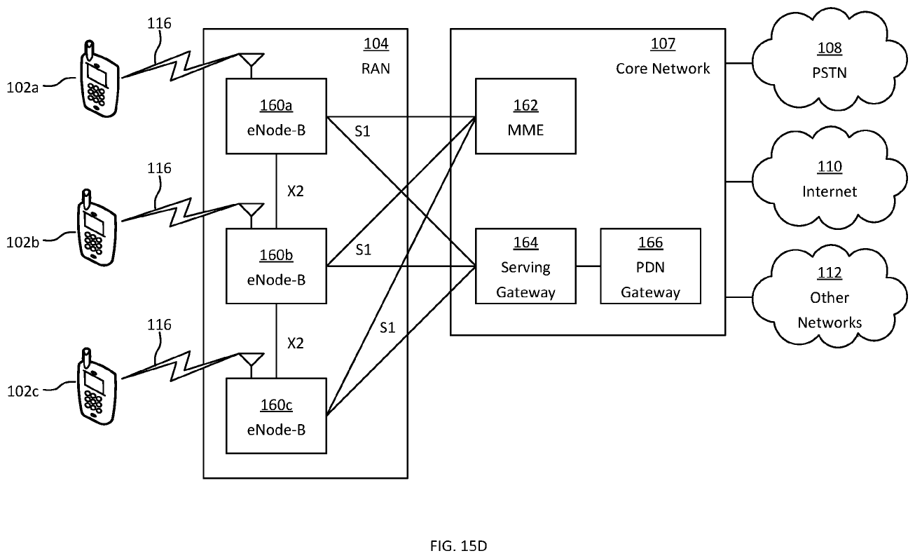

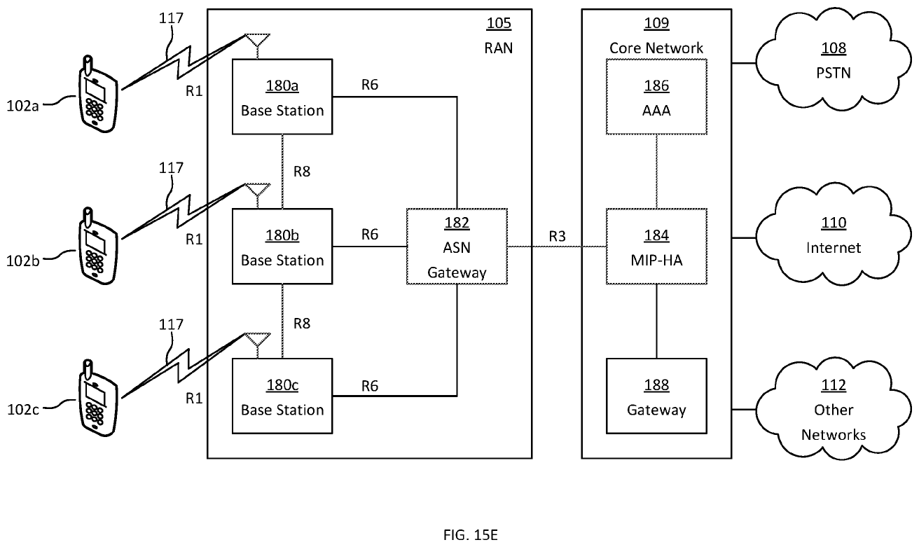

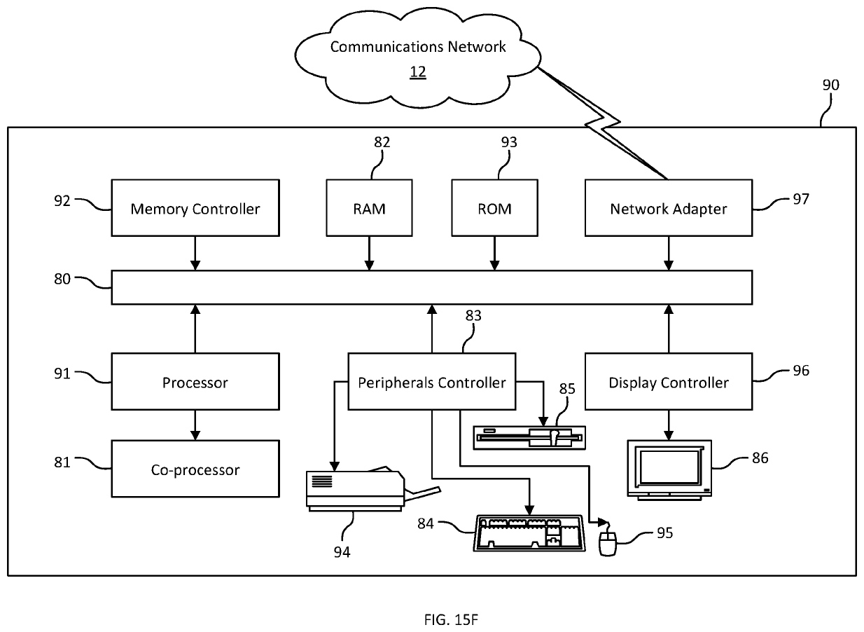

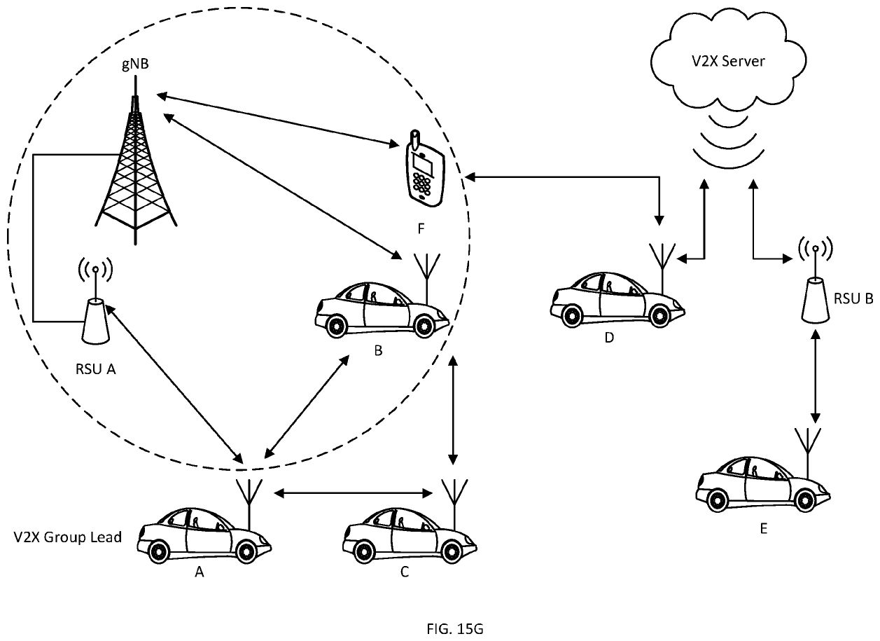

FIG. 15A illustrates an example communications system 100 in which the methods and apparatuses described and claimed herein may be an aspect of. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed examples contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 10A-10E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, the base station 114a may include three transceivers, e.g., one for each sector of the cell. In some cases, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In some cases, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In some cases, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 15A may be a wireless router, Home Node B, Home eNode B, or access point, for example, and may utilize any suitable RAT for facilitating wireless connectivity in a localized area, such as a place of business, a home, a vehicle, a campus, and the like. In some cases, the base station 114c and the WTRUs 102e, may implement a radio technology such as IEEE 802.11 to establish a wireless local area network (WLAN). In some cases, the base station 114c and the WTRUs 102d, may implement a radio technology such as IEEE 802.15 to establish a wireless personal area network (WPAN). In some cases, the base station 114c and the WTRUs 102e, may utilize a cellular-based RAT (e.g., WCDMA, CDMA2000, GSM, LTE, LTE-A, etc.) to establish a picocell or femtocell. As shown in FIG. 15A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VOIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 15A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 15A may be configured to communicate with the base station 114a, which may employ a cellular-based radio technology, and with the base station 114c, which may employ an IEEE 802 radio technology.

FIG. 15B is a block diagram of an example apparatus or device configured for wireless communications in accordance with the aspects illustrated herein, such as for example, a WTRU 102. As shown in FIG. 15B, the example WTRU 102 may include a processor 118, a transceiver 120, a transmit/receive element 122, a speaker/microphone 124, a keypad 113, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an example. Also, in some cases the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 15B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 15B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in some cases, the transmit/receive element 122 may be an antenna configured to transmit and/or receive RF signals. In some cases, the transmit/receive element 122 may be an emitter/detector configured to transmit and/or receive IR, UV, or visible light signals, for example. In some cases, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 15B as a single element, the WTRU 102 may include any number of transmit/receive elements 122. More specifically, the WTRU 102 may employ MIMO technology. Thus, in some cases, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In some cases, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an aspect.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 15C is a system diagram of the RAN 103 and the core network 106. As noted above, the RAN 103 may employ a UTRA radio technology to communicate with the WTRUs 102a, 102b, and 102c over the air interface 115. The RAN 103 may also be in communication with the core network 106. As shown in FIG. 15C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an aspect of the disclosure.

As shown in FIG. 15C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 15C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 15D is a system diagram of the RAN 104 and the core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an aspect of the disclosure. The eNode-Bs 160a, 160b, 160c may each include one or more transceivers for communicating with the WTRUs 102a, 102b, 102c over the air interface 116. In some cases, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 15D, the eNode-Bs 160a, 160b, 160c may communicate with one another over an X2 interface.

The core network 107 shown in FIG. 15D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 15E is a system diagram of the RAN 105 and the core network 109. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 15E, the RAN 105 may include base stations 180a, 180b, 180c, and an ASN gateway 182, though it will be appreciated that the RAN 105 may include any number of base stations and ASN gateways while remaining consistent with an aspect of the disclosure. The base stations 180a, 180b, 180c may each be associated with a particular cell in the RAN 105 and may include one or more transceivers for communicating with the WTRUs 102a, 102b, 102c over the air interface 117. In some cases, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 15E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 15E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 10A, 10C, 10D, and 10E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 10A, 10B, 10C, 10D, and 10E are provided by way of example only, and it is understood that the subject matter disclosed and claimed herein may be embodied or implemented in any similar communication system, whether presently defined or defined in the future.

FIG. 15F is a block diagram of an exemplary computing system 90 in which one or more apparatuses of the communications networks illustrated in FIGS. 10A, 10C, 10D and 10E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 10A, 10B, 10C, 10D, and 10E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 15G illustrates an example communications system 111 in which the methods and apparatuses described and claimed herein may be an aspect of. As shown, the example communications system 111 may include wireless transmit/receive units (WTRUs) A, B, C, D, E, F, a base station, a V2X server, and a RSUs A and B, though it will be appreciated that the disclosure contemplates any number of WTRUs, base stations, networks, and/or network elements. One or several or all WTRUs A, B, C, D, E can be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

### Definitions

Provided below are definitions for abbreviations found within the body of the disclosure.

| | |
|---|---|
| API | Application Programming Interface |
| GUI | Graphical User Interface |
| IP | Internet Protocol |
| ML | Machine Learning |
| URI | Uniform Resource Identifier |
| URL | Uniform Resource Locator |

Provided below are definitions for terms found within the body of the disclosure.

| | |
|---|---|
| Data preparation | Performing operations on an ML data set such as correcting inconsistencies, anomalies, missing or outlier values. Enriching data, |
| | synthesizing data, transforming data, performing feature engineering, labelling data for the training, validation, and testing of an ML |
| | algorithm or model. |
| Dataset context | Information added to a dataset to assist with the configuration of functions and operations in the data preparation process; also |
| information | includes description of relationships among the features and other information about the dataset |
| Feature metadata | The information associated with each feature of a dataset |
| User | A person, application or device that interacts with the data preparation service via a GUI or API. |

What is claimed:

1. A method by a data preparation service, comprising:
receiving, from a client, configuration information and output requirements for a machine learning (ML) application;
transmitting, to the client, data preparation recommendations for the client based on the received configuration information and the received output requirements;
receiving, from the client, one or more data preparation requests comprising at least identifiers of input data for processing by the data preparation service;
generating dataset metadata and context information via processing the input data;
determining a set of configurations of one or more remaining functions of the data preparation service based on the generated dataset metadata and context information; and
causing the input data to be further processed by the one or more remaining functions of the data preparation service according to the set of configurations.

2. The method of claim 1, further comprising:
generating output data based on the further processing of the input data.

3. The method of claim 1, wherein the set of configurations comprise a data synthesizer operation, a data cleaning operation, a data transform operation, a data labeling operation, or a combination thereof.

4. The method of claim 1, wherein the determining the set of configurations is further based on the data preparation recommendations.

5. The method of claim 1, wherein the one or more functions comprise an analytics/ML function, a data synthesizer function, a data clean function, a data transform function, a data labeling function, a data output function, or a combination thereof.

6. The method of claim 1, further comprising:
modifying a set of initial configurations for the one or more remaining functions according to the set of configurations.

7. The method of claim 1, wherein the at least identifiers for the input data comprise the input data.

8. The method of claim 1, further comprising:
receiving, from the client, a response to the data preparation recommendations comprising permissions to enforce the data preparation recommendations.

9. The method of claim 1, further comprising:
determining the data preparation recommendations based on an identifier for the ML application, an identifier of the client, learned behavior for the ML application, learned behavior for the client, or a combination thereof.

10. The method of claim 1, wherein the dataset metadata comprises numerical or categorical representations of the input data, data formats and types of the input data, units of measurements for the input data, data enumerations for the input data, range of values for the input data, identification of data to specific industries of the input data, or a combination thereof.

11. The method of claim 1, wherein configuration and output requirements comprise a ML application type, a maximum input feature value, one or more required output features, a minimum number of data samples, a target feature for the ML application, a target algorithm or model for the ML application, an output percentage of dataset samples for training, validating, and testing purposes, a permission for automating a data preparation workflow, or a combination thereof.

12. An apparatus for a data preparation service, the apparatus comprising circuitry configured to:
receive, from a client, configuration information and output requirements for a machine learning (ML) application;
transmit, to the client, data preparation recommendations for the client based on the received configuration information and the received output requirements;
receive, from the client, one or more data preparation requests comprising at least identifiers of input data for processing by the data preparation service;
generate dataset metadata and context information via processing the input data;
determine a set of configurations of one or more remaining functions of the data preparation service based on the generated dataset metadata and context information; and
cause the input data to be further processed by the one or more remaining functions of the data preparation service according to the set of configurations.

13. The method of claim 12, wherein the circuitry is further configured to:
generate output data based on the further processing of the input data.

14. The apparatus of claim 12, wherein the set of configurations comprise a data synthesizer operation, a data cleaning operation, a data transform operation, a data labeling operation, or a combination thereof.

15. The apparats of claim 12, wherein the determining the set of configurations is further based on the data preparation recommendations.

16. The apparatus of claim 12, wherein the one or more functions comprise an analytics/ML function, a data synthesizer function, a data clean function, a data transform function, a data labeling function, a data output function, or a combination thereof.

17. The apparatus of claim 12, wherein the circuitry is further configured to:
modify a set of initial configurations for the one or more remaining functions according to the set of configurations.

18. The apparatus of claim 12, wherein the at least identifiers for the input data comprise the input data.

19. The apparatus of claim 12, wherein the circuitry is further configured to:
receive, from the client, a response to the data preparation recommendations comprising permissions to enforce the data preparation recommendations.

20. A non-transitory computer-readable medium storing computer-executable instructions that, when executed by a processor, cause a data preparation service to:
receive, from a client, configuration information and output requirements for a machine learning (ML) application;
transmit, to the client, data preparation recommendations for the client based on the received configuration information and the received output requirements;
receive, from the client, one or more data preparation requests comprising at least identifiers of input data for processing by the data preparation service;
generate dataset metadata and context information via processing the input data;
determine a set of configurations of one or more remaining functions of the data preparation service based on the generated dataset metadata and context information; and
cause the input data to be further processed by the one or more remaining functions of the data preparation service according to the set of configurations.
